(19) United States
(12) Patent Application Publication
(10) Pub. No.: US 2026/0235780 A1
(43) Pub. Date: Aug. 13, 2026

(54) SEISMIC SURVEY FRAMEWORK

(71) Applicant: SCHLUMBERGER TECHNOLOGY CORPORATION, Sugar Land, TX (US)

(72) Inventors: Atul Laxman KATOLE, Houston, TX (US); Tao Zhao, Houston, TX (US); Wenyi Hu, Houston, TX (US); Aria Abubakar, Houston, TX (US); Thomas Dombrowsky, Abingdon (GB); Thomas Gehrmann, Stavanger (NO); Erik Dahl, Aberdeen (GB); Michael Cleminson, Crawley (GB)

(21) Appl. No.: 19/153,620

(22) PCT Filed: May 1, 2024
(86) PCT No.: PCT/US2024/027179

§ 371 Date: Aug. 5, 2025

Related U.S. Application Data
(60) Provisional application No. 63/463,149, filed on May 1, 2023.

(51) Int. Cl. G01V 1/30

(52) U.S. Cl. CPC G01V 1/30

(57) ABSTRACT

A method can include accessing a seismic data file for a seismic survey defined in part by a bin grid, where seismic data in the seismic data file are organized according to a data structure that includes headers and seismic trace data; performing an assessment of orthogonality of the bin grid of the seismic data file; responsive to detection of an orthogonality issue by the assessment, determining an orthogonal bin grid; extracting a trace header template using at least one of one or more introductory headers, where the trace header template specifies at least trace locations; performing a validation operation for validation of the trace header template; and, responsive to validation of the trace header template, outputting metadata that comports with the orthogonal bin grid and the validated trace header template for loading of the seismic data file to a data storage system.

### RELATED APPLICATIONS

This application claims priority to and the benefit of a U.S. Provisional Application having Ser. No. 63/463,149, filed 1 May 2023, which is incorporated by reference herein in its entirety.

### BACKGROUND

A sedimentary basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.). Such a reservoir can be a subsurface formation characterized by physical properties such as, for example, porosity and fluid permeability.

One or more seismic surveys can be utilized to image a sedimentary basin, which may be performed in parallel, in series, etc. For example, consider a single 3D seismic survey or a series of 3D seismic surveys that form a 4D seismic survey where changes in a sedimentary basin can be tracked with respect to time. A seismic survey can acquire seismic data (e.g., in a frequency range of approximately 1 Hz to approximately 100 Hz) that can be interpreted, processed, etc. For example, consider machine-based and/or human-based interpretation and/or machine-based reflection tomography (e.g., using a velocity model, etc.). Whether through interpretation or processing, seismic data can be utilized to understand better composition, fluid content, extent, and geometry of subsurface rocks.

Various types of computational frameworks provide for handling a seismic data file where a computational framework may demand a particular format for intake of seismic data that may differ from a raw data format. Hence, a seismic data file may be modified with modifications that do not exist in a raw seismic data file. A computational framework may process seismic data to identify various types of features (e.g., stratigraphic layers, faults, etc.) that may be used to create a structural model of a sedimentary basin. Such a model may be a basis for analysis, further modeling, simulation, etc. Phenomena associated with a sedimentary basin may be modeled using a mesh, a grid, etc. For example, consider a reservoir simulation model that can be utilized by a reservoir simulator to generate simulation results for pressure, fluid flow, etc. As another example, consider a geomechanics simulation model that can be utilized by a geomechanics simulator to generate simulation results for structural changes in a sedimentary basin (e.g., compaction due to fluid production, etc.). Various operations may be performed in the field to access hydrocarbon fluids and/or produce hydrocarbon fluids where one or more of such operations can be based in part on seismic data from one or more seismic surveys. For example, a simulation model can be based on interpretation of seismic data where simulation results can dictate how one or more field operations are performed.

As explained, a seismic data file may be modified (e.g., transformed or otherwise altered), for example, to make seismic data compatible with a computational framework and/or to make seismic data comport with a particular coordinate reference system (CRS). Such changes may alter data structures, text, coordinates, units, etc. As seismic data (e.g., a seismic cube, a seismic volume, etc.) can be quite extensive in size (e.g., gigabytes to terabytes or more), memory and storage related issues and associated decisions may arise. For example, where a raw seismic data file is modified for input to a particular framework, to conserve storage space, a decision may be made to store a modified seismic data file without retaining the raw seismic data file (e.g., allowing for overwriting, etc.). In such an example, where information in the raw seismic data file is desired, it may no longer exist. And, where an available version of the seismic data is not compatible for a desired use (e.g., a framework, etc.), while there may be an option for performing a new seismic survey, that option is likely to be time consuming and resource intensive. Additionally, in the realm of machine learning based on seismic data, the amount of available training data may be limited for one or more reasons. For example, consider seismic data that are proprietary, available with restrictions as to use, available in an undesirable format, etc. Such challenges can place an emphasis on making the most of seismic data files at hand.

Various technologies, techniques, etc., described herein pertain to accessing and processing a seismic data file to make seismic data therein suitable for one or more uses.

While hydrocarbon fluid reservoirs are mentioned as an example, seismic data for a reservoir that includes water and brine may be accessed and processed, for example, for one or more purposes such as, for example, carbon storage (e.g., sequestration), water production or storage, geothermal production or storage, metallic extraction from brine, etc.

### SUMMARY

A method can include accessing a seismic data file for a seismic survey defined in part by a bin grid, where seismic data in the seismic data file are organized according to a data structure that includes headers and seismic trace data, where the headers include one or more introductory headers and multiple trace headers; performing an assessment of orthogonality of the bin grid of the seismic data file; responsive to detection of an orthogonality issue by the assessment, determining an orthogonal bin grid; extracting a trace header template using at least one of the one or more introductory headers, where the trace header template specifies at least trace locations; performing a validation operation for validation of the trace header template; and responsive to validation of the trace header template, outputting metadata that comports with the orthogonal bin grid and the validated trace header template for loading of the seismic data file to a data storage system.

A system can include a processor; a memory operatively coupled to the processor; processor-executable instructions stored in the memory and executable to instruct the system to: access a seismic data file for a seismic survey defined in part by a bin grid, where seismic data in the seismic data file are organized according to a data structure that includes headers and seismic trace data, where the headers include one or more introductory headers and multiple trace headers; perform an assessment of orthogonality of the bin grid of the seismic data file; responsive to detection of an orthogonality issue by the assessment, determine an orthogonal bin grid; extract a trace header template using at least one of the one or more introductory headers, where the trace header template specifies at least trace locations; perform a validation operation for validation of the trace header template; and, responsive to validation of the trace header template, output metadata that comports with the orthogonal bin grid and the validated trace header template for loading of the seismic data file to a data storage system.

One or more computer-readable storage media can include processor-executable instructions executable by a system to instruct the system to: access a seismic data file for a seismic survey defined in part by a bin grid, where seismic data in the seismic data file are organized according to a data structure that includes headers and seismic trace data, where the headers include one or more introductory headers and multiple trace headers; perform an assessment of orthogonality of the bin grid of the seismic data file; responsive to detection of an orthogonality issue by the assessment, determine an orthogonal bin grid; extract a trace header template using at least one of the one or more introductory headers, where the trace header template specifies at least trace locations; perform a validation operation for validation of the trace header template; and, responsive to validation of the trace header template, output metadata that comports with the orthogonal bin grid and the validated trace header template for loading of the seismic data file to a data storage system.

Various other apparatuses, systems, methods, etc., are also disclosed. This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for simulating a geological environment;

FIG. 2 illustrates an example of a system;

FIG. 3 illustrates an example of a method;

FIG. 4 illustrates an example of a data structure;

FIG. 5 illustrates an example of a method;

FIG. 6 illustrates examples of bin grids;

FIG. 7 illustrates an example of a method;

FIG. 8 illustrates an example of a technique;

FIG. 9 illustrates an example of a technique;

FIG. 10 illustrates an example of a method;

FIG. 11 illustrates an example of a method;

FIG. 12 illustrates an example of a method;

FIG. 13 illustrates an example of a graphical user interface;

FIG. 14 illustrates an example of a graphical user interface;

FIG. 15 illustrates an example of a graphical user interface;

FIG. 16 illustrates an example of a method;

FIG. 17 illustrates an example of a method;

FIG. 18 illustrates an example of a method;

FIG. 19 illustrates an example of a method;

FIG. 20 illustrates an example of a method and an example of a system; and

FIG. 21 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

As explained, a seismic data file from a seismic survey can be relatively large in size (e.g., terabytes or more) and may be available in one or more formats (e.g., data structures, CRSs, etc.). As an example, a seismic survey framework can access a seismic data file and process it to generate metadata that provides for loading of the seismic data file in an original format.

A seismic data file, as stored, can differ from an original raw seismic data file. For example, a raw seismic data file may have been subjected to one or more types of calculations, which may involve units, CRSs, data structure specifications, etc. As to a CRS, it can be a coordinate-based local, regional or global system used to locate geographical entities. A CRS can define a specific map projection, as well as transformations between different CRSs. CRSs may be referred to using a spatial reference identifier (SRID) integer, including European Petroleum Survey Group (EPSG) codes defined by the International Association of Oil and Gas Producers (IAOGP) that can be specified in ISO 19111:2007 Geographic information—Spatial referencing by coordinates, prepared by ISO/TC 211, also published as an Open Geospatial Consortium (OGC) Abstract Specification, Topic 2: Spatial referencing by coordinates. As an example, a CRS can be a collection of X (easting), Y (northing), and Z (elevation or depth) values in a defined datum and subdivided into smaller zones. As an example, WGS84 UTM Zone 14 North is in the center of the State of Texas.

As to raw seismic data in an original seismic data file, a seismic survey can employ an acquisition technique utilizing equipment that can emit energy from a source (e.g., a transmitter) and receive reflected energy via one or more sensors (e.g., receivers). As a region can include layers, energy emitted by a transmitter of the equipment can reflect off the layers. Evidence of such reflections may be found in the acquired traces. A trace, energy received by a receiver with respect to time, may be discretized by an analog-to-digital converter that may operate at a sampling rate. For example, equipment may convert energy signals sensed by a sensor to digital samples at a rate of one sample per approximately 4 ms. Given a speed of sound in a medium or media, a sample rate may be converted to an approximate distance. For example, the speed of sound in rock may be on the order of around 5 km per second. Thus, a sample time spacing of approximately 4 ms would correspond to a sample “depth” spacing of about 10 meters (e.g., assuming a path length from source to boundary and boundary to sensor). As an example, a trace may be about 4 seconds in duration; thus, for a sampling rate of one sample at about 4 ms intervals, such a trace would include about 1000 samples where latter acquired samples correspond to deeper reflection boundaries. If the 4 second trace duration of the foregoing example is divided by two (e.g., to account for reflection), for a vertically aligned source and sensor, the deepest boundary depth may be estimated to be about 10 km (e.g., assuming a speed of sound of about 5 km per second). As explained, sampling and depth may be related, noting that a sampling rate may define, at least in part, a resolution of a seismic survey.

As to geometry of a seismic survey, it may be referred to as an acquisition geometry. As an example, an acquisition geometry can be defined using a grid with inline (IL or Inline) and crossline (XL or xline or Xline) locations. As an example, a seismic survey may include more than 100 grid points, where each grid point represents a location, which, for example, may be a mid-point location between a source and a receiver. In a marine seismic survey, streamers may be utilized that are towed by a vessel such that receivers move in time, or, for example, ocean bottom nodes (OBNs) or ocean bottom cables (OBCs) may be utilized that are stationary. For land seismic surveys, receivers may be stationary. The nature of an acquisition geometry can impact acquired data. For example, variations in properties of seismic data can be encountered during processing that are related to the acquisition geometry, which may distort amplitude and phase of reflections. As an example, an acquisition geometry may be designed as a regular grid where 90 degree angles exist at four corners of the grid. Depending on size of an acquisition geometry, it may account for curvature of the Earth (e.g., geodetic coordinates); noting that such an acquisition geometry can be projected to a plane (e.g., referencing a CRS). In general, an acquisition geometry may be represented by straight lines (e.g., ILs and XLs), whether in native form or as projected. In various instances, distortions may arise for one or more reasons during modification of seismic data and/or information in a seismic data file where such distortions may be desirable or undesirable. For example, a particular framework may specify a format where a transformation from raw seismic data to the specified format introduces known distortions (e.g., bin grid distortions, etc.).

As an example, data such as seismic data may be formatted in a seismic data file according to one of the SEG-Y format standards (Society of Exploration Geophysicists), the ZGY format standard (e.g., a bricked format) or another format. As an example, seismic data may be stored with trace header information, which may assist in analysis of the seismic data. Seismic data may optionally be accessed, for example, according to a number of traces (e.g., in an IL, XL or IL and XL directions), which may be entire traces or portions thereof (e.g., for one or more particular times or depths). As an example, given a number of traces across a region, a process may access some of those traces in a sub-region by specifying IL and XL indices (e.g., or geographic or grid coordinates) as well as a time or depth window.

In the oil and gas industry and other industries, various types of geophysical data are generated (e.g., seismic data, etc.). As explained, geophysical data can be used by exploration and production personnel to ascertain the presence, nature and size of subsurface rock layers and reservoirs contained therein. Geophysics encompasses the physics of the planet.

Below, various types of environments, frameworks, workflows, data acquisition techniques, etc., are described, which may involve use of seismic survey data, for example, as processed using a seismic survey framework.

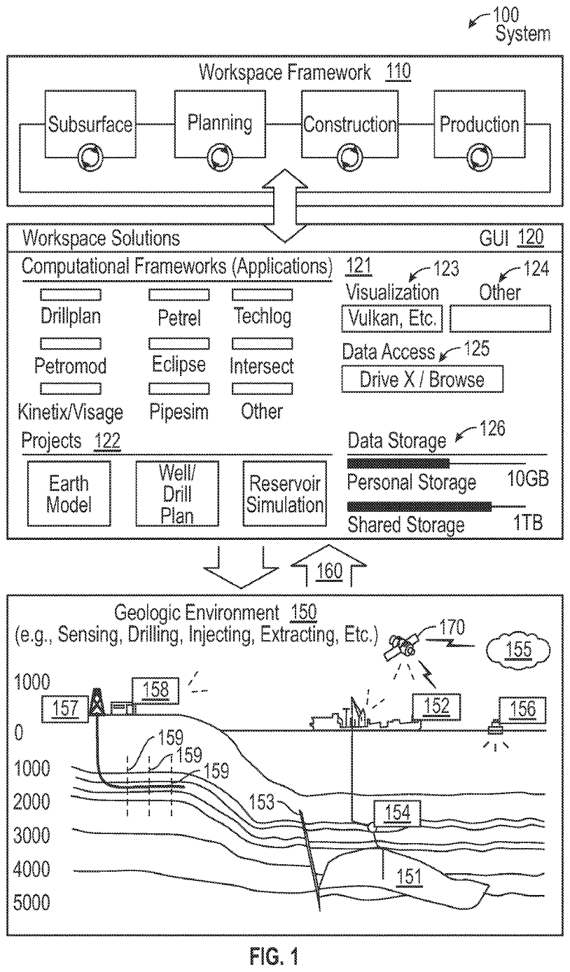

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. A geologic environment 150 may be outfitted with a variety of sensors, detectors, actuators, etc. In such an environment, various types of equipment such as, for example, equipment 152 may include communication circuitry to receive and to transmit information, optionally with respect to one or more networks 155. Such information may include information associated with downhole equipment 154, which may be equipment to acquire information, to assist with resource recovery, etc. Other equipment 156 may be located remote from a wellsite and include sensing, detecting, emitting, or other circuitry. Such equipment may include storage and communication circuitry to store and to communicate data, instructions, etc. One or more satellites may be provided for purposes of communications, data acquisition, etc. For example, FIG. 1 shows a satellite 170 in communication with the network 155 that may be configured for communications, noting that the satellite 170 may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc., may exist where an assessment of such variations may assist with planning, operations, etc., to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, PETREL, TECHLOG, PETROMOD, ECLIPSE, INTERSECT, KINETIX/VISAGE, and PIPESIM frameworks (SLB, Houston, Texas). One or more types of frameworks may be implemented within or in a manner operatively coupled to the DELFI environment, which is a secure, cognitive, cloud-based collaborative environment that integrates data and workflows with digital technologies, such as artificial intelligence (Al) and machine learning (ML). Such an environment can provide for operations that involve one or more frameworks. The DELFI environment may be referred to as the DELFI framework, which may be a framework of frameworks. The DELFI environment can include various other frameworks, which may operate using one or more types of models (e.g., simulation models, etc.).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework can be part of the DELFI cognitive exploration and production (E&P) environment (SLB, Houston, Texas, referred to as the DELFI environment) for utilization in geosciences and geoengineering, for example, to analyze subsurface data from exploration to production of fluid from a reservoir.

The TECHLOG framework can handle and process field and laboratory data for a variety of geologic environments (e.g., deepwater exploration, shale, etc.). The TECHLOG framework can structure wellbore data for analyses, planning, etc.

The PETROMOD framework provides petroleum systems modeling capabilities that can combine one or more of seismic, well, and geological information to model the evolution of a sedimentary basin. The PETROMOD framework can predict if, and how, a reservoir has been charged with hydrocarbons, including the source and timing of hydrocarbon generation, migration routes, quantities, and hydrocarbon type in the subsurface or at surface conditions.

The ECLIPSE framework provides a reservoir simulator with numerical solvers for prediction of dynamic behavior for various types of reservoirs and development schemes.

The INTERSECT framework provides a high-resolution reservoir simulator for simulation of geological features and quantification of uncertainties, for example, by creating production scenarios and, with the integration of precise models of the surface facilities and field operations, the INTERSECT framework can produce results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed chemical-enhanced-oil-recovery (EOR) formulations where such formulations can be implemented in the field, can analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI environment, for example, for rapid simulation of multiple concurrent cases.

The KINETIX framework provides for reservoir-centric stimulation-to-production analyses that can integrate geology, petrophysics, completion engineering, reservoir engineering, and geomechanics, for example, to provide for optimized completion and fracturing designs for a well, a pad, or a field. The KINETIX framework can be operatively coupled to and/or integrated with features of the PETREL framework (e.g., within the DELFI environment). As to the VISAGE framework it can be part of or otherwise operatively coupled to the KINETIX framework.

The VISAGE framework includes finite element numerical solvers that may provide simulation results such as, for example, results as to compaction and subsidence of a geologic environment, well and completion integrity in a geologic environment, cap-rock and fault-seal integrity in a geologic environment, fracture behavior in a geologic environment, thermal recovery in a geologic environment, CO2 disposal, etc.

As an example, the KINETIX framework can provide for analyses from 1D logs and simple geometric completions to 3D mechanical and petrophysical models coupled with the INTERSECT framework high-resolution reservoir simulator and VISAGE framework finite-element geomechanics simulator. The KINETIX framework can provide automated parallel processing using cloud platform resources and can provide for rapid assessment of well spacing, completion, and treatment design choices, enabling exploration of many scenarios in a relatively rapid manner (e.g., via provisioning of cloud platform resources). The KINETIX framework may be operatively coupled to the MANGROVE simulator (SLB, Houston, Texas), which can provide for optimization of stimulation design (e.g., stimulation treatment operations such as hydraulic fracturing) in a reservoir-centric environment.

The MANGROVE framework can combine scientific and experimental work to predict geomechanical propagation of hydraulic fractures, reactivation of natural fractures, etc., along with production forecasts within 3D reservoir models (e.g., production from a drainage area of a reservoir where fluid moves via one or more types of fractures to a well and/or from a well). The MANGROVE framework can provide results pertaining to heterogeneous interactions between hydraulic and natural fracture networks, which may assist with optimization of the number and location of fracture treatment stages (e.g., stimulation treatment(s)), for example, to increased perforation efficiency and recovery.

The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (SLB, Houston Texas). The PIPESIM simulator may be an optimizer that can optimize one or more operational scenarios at least in part via simulation of physical phenomena.

As an example, a framework with features for performing drilling operations, etc., may be included in the system 100. For example, consider the DRILLOPS framework (SLB, Houston, Texas), which may execute a digital drilling plan and ensures plan adherence, while delivering goal-based automation. The DRILLOPS framework may generate activity plans automatically for operations, whether they are monitored and/or controlled on the rig or in town. Automation may utilize data analysis and learning systems to assist and optimize tasks, such as, for example, setting rate of penetration (ROP) to drilling a stand. A preset menu of automatable drilling tasks may be rendered, and, using data analysis and models, a plan may be executed in a manner to achieve a specified goal, where, for example, measurements may be utilized for calibration. The DRILLOPS framework provides flexibility to modify and replan activities dynamically, for example, based on a live appraisal of various factors (e.g., equipment, personnel, and supplies). Well construction activities (e.g., tripping, drilling, cementing, etc.) may be continually monitored and dynamically updated using feedback from operational activities. The DRILLOPS framework may provide for various levels of automation based on planning and/or re-planning (e.g., via the DRILLPLAN framework), feedback, etc.

As an example, a framework with features for performing seismic data related operations, etc., may be included in the system 100. For example, consider the OMEGA framework (SLB, Houston, Texas), which includes finite difference modelling (FDMOD) features for two-way wavefield extrapolation modelling, generating synthetic shot gathers with and without multiples. The FDMOD features can generate synthetic shot gathers by using full 3D, two-way wavefield extrapolation modelling, which can utilize wavefield extrapolation logic matches that are used by reverse-time migration (RTM). A model may be specified on a dense 3D grid as velocity and optionally as anisotropy, dip, and variable density. The OMEGA framework also includes features for RTM, FDMOD, adaptive beam migration (ABM), Gaussian packet migration (Gaussian PM), depth processing (e.g., Kirchhoff prestack depth migration (KPSDM), tomography (Tomo)), time processing (e.g., Kirchhoff prestack time migration (KPSTM), general surface multiple prediction (GSMP), extended interbed multiple prediction (XIMP)), framework foundation features, desktop features (e.g., GUIs, etc.), and development tools. Various features can be included for processing various types of data such as, for example, one or more of: land, marine, and transition zone data; time and depth data; 2D, 3D, and 4D surveys; isotropic and anisotropic (TTI and VTI) velocity fields; and multicomponent data.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150, and feedback 160 can be received via one or more interfaces in one or more forms (e.g., acquired data as to operational conditions, equipment conditions, environment conditions, etc.).

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

Visualization features may provide for visualization of various earth models, properties, etc., in one or more dimensions. As an example, visualization features may include one or more control features for control of equipment, which can include, for example, field equipment that can perform one or more field operations. A workflow may utilize one or more frameworks to generate information that can be utilized to control one or more types of field equipment (e.g., drilling equipment, wireline equipment, fracturing equipment, etc.). As an example, a framework such as the Vulkan framework (Khronos Group, Beaverton, Oregon) may be available or otherwise accessible for implementing various visualization techniques, etc. The Vulkan framework may provide relatively a low-level, low-overhead cross-platform API and open standard for 3D graphics and computing.

As to a reservoir model that may be suitable for utilization by a simulator, consider acquisition of seismic data as acquired via reflection seismology, which finds use in geophysics, for example, to estimate properties of subsurface formations. Seismic data may be processed and interpreted, for example, to understand better composition, fluid content, extent and geometry of subsurface rocks. Such interpretation results can be utilized to plan, simulate, perform, etc., one or more operations for production of fluid from a reservoir (e.g., reservoir rock, etc.). Field acquisition equipment may be utilized to acquire seismic data, which may be in the form of traces where a trace can include values organized with respect to time and/or depth (e.g., consider 1D, 2D, 3D or 4D seismic data).

A model may be a simulated version of a geologic environment where a simulator may include features for simulating physical phenomena in a geologic environment based at least in part on a model or models. A simulator, such as a reservoir simulator, can simulate fluid flow in a geologic environment based at least in part on a model that can be generated via a framework that receives seismic data. A simulator can be a computerized system (e.g., a computing system) that can execute instructions using one or more processors to solve a system of equations that describe physical phenomena subject to various constraints. In such an example, the system of equations may be spatially defined (e.g., numerically discretized) according to a spatial model that that includes layers of rock, geobodies, etc., that have corresponding positions that can be based on interpretation of seismic and/or other data. A spatial model may be a cell-based model where cells are defined by a grid (e.g., a mesh). A cell in a cell-based model can represent a physical area or volume in a geologic environment where the cell can be assigned physical properties (e.g., permeability, fluid properties, etc.) that may be germane to one or more physical phenomena (e.g., fluid volume, fluid flow, pressure, etc.). A reservoir simulation model can be a spatial model that may be cell-based.

While several simulators are illustrated in the example of FIG. 1, one or more other simulators may be utilized, additionally or alternatively.

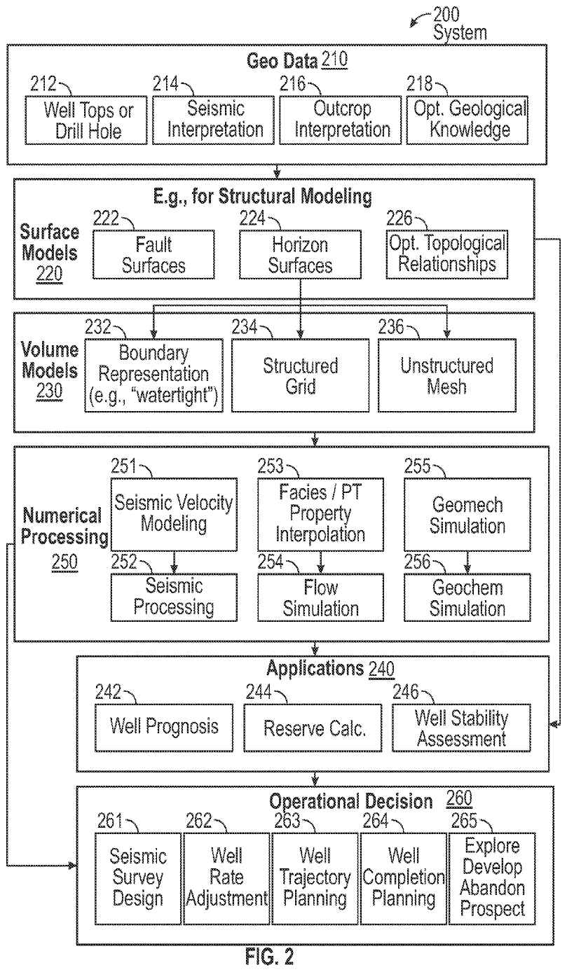

FIG. 2 shows an example of a system 200 that can be operatively coupled to one or more databases, data streams, etc. For example, one or more pieces of field equipment, laboratory equipment, computing equipment (e.g., local and/or remote), etc., can provide and/or generate data that may be utilized in the system 200.

As shown, the system 200 can include a geological/geophysical data block 210, a surface models block 220 (e.g., for one or more structural models), a volume modules block 230, an applications block 240, a numerical processing block 250 and an operational decision block 260. As shown in the example of FIG. 2, the geological/geophysical data block 210 can include data from well tops or drill holes 212, data from seismic interpretation 214, data from outcrop interpretation and optionally data from geological knowledge. As an example, the geological/geophysical data block 210 can include data from digital images, which can include digital images of cores, cuttings, cavings, outcrops, etc. As to the surface models block 220, it may provide for creation, editing, etc. of one or more surface models based on, for example, one or more of fault surfaces 222, horizon surfaces 224 and optionally topological relationships 226. As to the volume models block 230, it may provide for creation, editing, etc. of one or more volume models based on, for example, one or more of boundary representations 232 (e.g., to form a watertight model), structured grids 234 and unstructured meshes 236.

As shown in the example of FIG. 2, the system 200 may allow for implementing one or more workflows, for example, where data of the data block 210 are used to create, edit, etc. one or more surface models of the surface models block 220, which may be used to create, edit, etc. one or more volume models of the volume models block 230. As indicated in the example of FIG. 2, the surface models block 220 may provide one or more structural models, which may be input to the applications block 240. For example, such a structural model may be provided to one or more applications, optionally without performing one or more processes of the volume models block 230 (e.g., for purposes of numerical processing by the numerical processing block 250). Accordingly, the system 200 may be suitable for one or more workflows for structural modeling (e.g., optionally without performing numerical processing per the numerical processing block 250).

As to the applications block 240, it may include applications such as a well prognosis application 242, a reserve calculation application 244 and a well stability assessment application 246. As to the numerical processing block 250, it may include a process for seismic velocity modeling 251 followed by seismic processing 252, a process for facies and petrophysical property interpolation 253 followed by flow simulation 254, and a process for geomechanical simulation 255 followed by geochemical simulation 256. As indicated, as an example, a workflow may proceed from the volume models block 230 to the numerical processing block 250 and then to the applications block 240 and/or to the operational decision block 260. As another example, a workflow may proceed from the surface models block 220 to the applications block 240 and then to the operational decisions block 260 (e.g., consider an application that operates using a structural model).

In the example of FIG. 2, the operational decisions block 260 may include a seismic survey design process 261, a well rate adjustment process 252, a well trajectory planning process 263, a well completion planning process 264 and a process for one or more prospects, for example, to decide whether to explore, develop, abandon, etc. a prospect.

Referring again to the data block 210, the well tops or drill hole data 212 may include spatial localization, and optionally surface dip, of an interface between two geological formations or of a subsurface discontinuity such as a geological fault; the seismic interpretation data 214 may include a set of points, lines or surface patches interpreted from seismic reflection data, and representing interfaces between media (e.g., geological formations in which seismic wave velocity differs) or subsurface discontinuities; the outcrop interpretation data 216 may include a set of lines or points, optionally associated with measured dip, representing boundaries between geological formations or geological faults, as interpreted on the earth surface; and the geological knowledge data 218 may include, for example knowledge of the paleo-tectonic and sedimentary evolution of a region.

As to a structural model, it may be, for example, a set of gridded or meshed surfaces representing one or more interfaces between geological formations (e.g., horizon surfaces) or mechanical discontinuities (fault surfaces) in the subsurface. As an example, a structural model may include some information about one or more topological relationships between surfaces (e.g. fault A truncates fault B, fault B intersects fault C, etc.).

As to the one or more boundary representations 232, they may include a numerical representation in which a subsurface model is partitioned into various closed units representing geological layers and fault blocks where an individual unit may be defined by its boundary and, optionally, by a set of internal boundaries such as fault surfaces.

As to the one or more structured grids 234, it may include a grid that partitions a volume of interest into different elementary volumes (cells), for example, that may be indexed according to a pre-defined, repeating pattern. As to the one or more unstructured meshes 236, it may include a mesh that partitions a volume of interest into different elementary volumes, for example, that may not be readily indexed following a pre-defined, repeating pattern (e.g., consider a Cartesian cube with indexes I, J, and K, along x, y, and z axes).

As to the seismic velocity modeling 251, it may include calculation of velocity of propagation of seismic waves (e.g., where seismic velocity depends on type of seismic wave and on direction of propagation of the wave). As to the seismic processing 252, it may include a set of processes allowing identification of localization of seismic reflectors in space, physical characteristics of the rocks in between these reflectors, etc.

As to the facies and petrophysical property interpolation 253, it may include an assessment of type of rocks and of their petrophysical properties (e.g., porosity, permeability), for example, optionally in areas not sampled by well logs or coring. As an example, such an interpolation may be constrained by interpretations from log and core data, and by prior geological knowledge.

As to the flow simulation 254, as an example, it may include simulation of flow of hydro-carbons in the subsurface, for example, through geological times (e.g., in the context of petroleum systems modeling, when trying to predict the presence and quality of oil in an un-drilled formation) or during the exploitation of a hydrocarbon reservoir (e.g., when some fluids are pumped from or into the reservoir).

As to geomechanical simulation 255, it may include simulation of the deformation of rocks under boundary conditions. Such a simulation may be used, for example, to assess compaction of a reservoir (e.g., associated with its depletion, when hydrocarbons are pumped from the porous and deformable rock that composes the reservoir). As an example, a geomechanical simulation may be used for a variety of purposes such as, for example, prediction of fracturing, reconstruction of the paleo-geometries of the reservoir as they were prior to tectonic deformations, etc.

As to geochemical simulation 256, such a simulation may simulate evolution of hydrocarbon formation and composition through geological history (e.g., to assess the likelihood of oil accumulation in a particular subterranean formation while exploring new prospects).

As to the various applications of the applications block 240, the well prognosis application 242 may include predicting type and characteristics of geological formations that may be encountered by a drill bit, and location where such rocks may be encountered (e.g., before a well is drilled); the reserve calculations application 244 may include assessing total amount of hydrocarbons or ore material present in a subsurface environment (e.g., and estimates of which proportion can be recovered, given a set of economic and technical constraints); and the well stability assessment application 246 may include estimating risk that a well, already drilled or to-be-drilled, will collapse or be damaged due underground stress.

As to the operational decision block 260, the seismic survey design process 261 may include deciding where to place seismic sources and receivers to optimize the coverage and quality of the collected seismic information while minimizing cost of acquisition; the well rate adjustment process 262 may include controlling injection and production well schedules and rates (e.g., to maximize recovery and production); the well trajectory planning process 263 may include designing a well trajectory to maximize potential recovery and production while minimizing drilling risks and costs; the well trajectory planning process 264 may include selecting proper well tubing, casing and completion (e.g., to meet expected production or injection targets in specified reservoir formations); and the prospect process 265 may include decision making, in an exploration context, to continue exploring, start producing or abandon prospects (e.g., based on an integrated assessment of technical and financial risks against expected benefits).

The system 200 can include and/or can be operatively coupled to a system such as the system 100 of FIG. 1. For example, the workspace framework 110 may provide for instantiation of, rendering of, interactions with, etc., the graphical user interface (GUI) 120 to perform one or more actions as to the system 200. In such an example, access may be provided to one or more frameworks (e.g., DRILLPLAN, PETREL, TECHLOG, PETROMOD, ECLIPSE, INTERSECT, KINETIX/VISAGE, PIPESIM, DRILLOPS, OMEGA, etc.). One or more frameworks may provide for geo data acquisition as in block 210, for structural modeling as in block 220, for volume modeling as in block 230, for running an application as in block 240, for numerical processing as in block 250, for operational decision making as in block 260, etc.

As an example, the system 200 may provide for monitoring data, which can include geo data per the geo data block 210. In various examples, geo data may be acquired during one or more operations. For example, consider acquiring geo data during drilling operations via downhole equipment and/or surface equipment. As an example, the operational decision block 260 can include capabilities for monitoring, analyzing, etc., such data for purposes of making one or more operational decisions, which may include controlling equipment, revising operations, revising a plan, etc. In such an example, data may be fed into the system 200 at one or more points where the quality of the data may be of particular interest. For example, data quality may be characterized by one or more metrics where data quality may provide indications as to trust, probabilities, etc., which may be germane to operational decision making and/or other decision making.

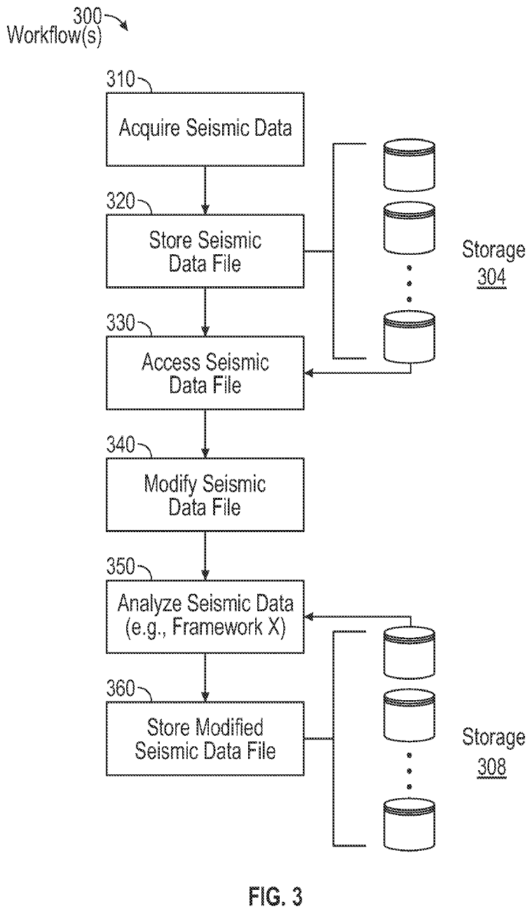

FIG. 3 shows an example of one or more workflows 300 that include an acquisition block 310 for acquiring seismic data, a storage block 320 for storing seismic data as a seismic data file (e.g., in a data storage 304), an access block 330 for accessing the seismic data file (e.g., from the data storage 304), a modification block 340 for modifying the seismic data file, an analysis block 350 for analyzing seismic data in the modified seismic data file (e.g., by framework X), and a storage block 360 for storing the modified seismic data file (e.g., in a data storage 308). In such an example, when a user wants to further analyze the modified seismic data, the user may instruct the analysis framework (e.g., framework X) to access the modified seismic data file from the data storage 308. In such an approach, the user does not have to access the seismic data as may be stored in raw form in the data storage 304, if those data even still exist. By accessing the modified seismic data file, the user of the framework can save considerable time (e.g., the modification block 340 may not be necessary).

As explained, in various instances, a user may desire an unmodified seismic data file or otherwise the seismic data as stored in the data storage 304; noting that the data storage 304 and the data storage 308 may be the same data storage equipment (e.g., servers and drives, etc.). Where the unmodified seismic data file is unavailable or not practically available for one or more reasons, a seismic survey framework may be implemented to transform the modified seismic data file to an unmodified form (e.g., a form prior to modification per the modification block 340). As an example, such a transformation may be via metadata, which may be generated and/or extracted using a seismic survey framework. In such an example, the metadata can provide for proper loading of seismic data within a seismic data file, for example, for storage to a data storage system.

As an example, a seismic survey framework can provide for implementing a data ingestion workflow that extracts metadata such that a seismic data file can be ingested into a cloud-platform database and/or consumed by one or more geophysics data analysis applications.

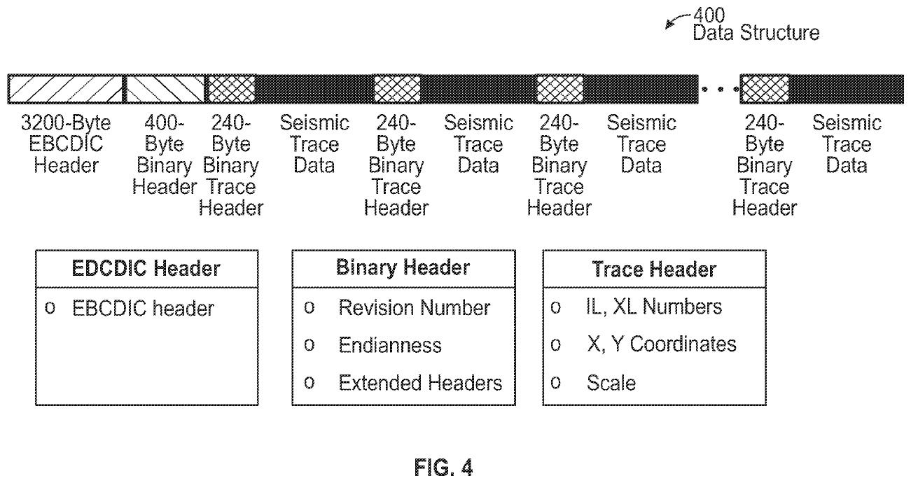

FIG. 4 shows an example of a data structure 400 for the SEG-Y (SEGY) format, which is taken as an example of a format for illustration in various examples. FIG. 4 also shows some types of metadata that can be within the data structure 400.

As shown, the first 3600-bytes of the data structure 400 are a Textual File Header and the Binary File Header written as a concatenation of a 3200-byte record and a 400-byte record. This is optionally followed by Extended Textual File Header(s), which can include zero or more 3200-byte Extended Textual File Header records. The remainder of the data structure 400 includes a variable number of Data Trace records that are each proceeded by a 240-byte Trace Header. As shown, the 3200-byte portion can be in an EBCDIC format (e.g., a text format such as in extended binary-coded decimal interchange code (EBCDIC)).

As to number formats, in the 1975 SEG-Y standard, binary values are defined as using “big-endian” byte ordering, which conformed to the IBM tape standard and means that, within the bytes that make up a number, the most significant byte (containing the sign bit) is written closest to the beginning of the file and the least significant byte is written closest to the end of the file. This byte ordering convention is maintained in later revision of the SEG-Y format and is to be adhered to for conforming versions of SEG-Y. This is independent of the medium to which a particular SEG-Y file is written (i.e., the byte ordering is no different if the file is written to tape on a mainframe, disk on a PC, drive of a server, etc.).

Values in the Binary File Header and the Trace Header are two's complement integers, either two bytes or four bytes long. There are no floating-point values defined in the headers. Trace Data sample values are either two's complement integers or floating-point; noting that one revision adds data sample formats of 8-bit integer and 32-bit IEEE floating-point. Both IBM floating-point (as defined in the original standard) and IEEE floating-point values are written in big-endian byte order (i.e., with the sign/exponent byte written closest to the beginning of the file).

As to Trace Data, SEG-Y allows for varying trace lengths. The SEG-Y standard specifies fields for sampling interval and number of samples at two separate locations in a file. The Binary File Header contains values that apply to the whole file and the Trace Headers include values that apply to the associated trace. As an example, data traces may be padded (e.g., zero padding) or truncated as appropriate. As an example, a Binary File Header can specify a duration of trace data and a sampling interval (e.g., six seconds of data sampled at a two-millisecond (2 ms) sampling interval). However, the value for the number of samples in each individual Trace Header may vary from the value in the Binary File Header and reflect the actual number of samples in a trace.

As to coordinates, knowing source and trace locations is a primary requirement for processing seismic data, and knowing the location of the processed data with respect to other data is beneficial for interpretation. Traditionally, seismic coordinates have been supplied as geographic coordinates and/or grid coordinates. SEG-Y accommodates either form. However, locations can be ambiguous without a clear coordinate reference system (CRS) definition. SEG-Y rev 1 expanded the ability to define the CRS used for the coordinates contained within the Binary Header, the Extended Textual Headers and the Trace Headers. A single CRS is to be used for coordinates within an individual SEG-Y data set. Additionally, the coordinate units are to be the same for all of the coordinates.

The first 3200-byte, Textual File Header record includes 40 lines of textual information, providing a human-readable description of the seismic data in the SEG-Y file. This information is free form and is the least well defined of the headers in the 1975 standard, although the standard did provide a suggested layout for the first 20 lines. While there would be distinct advantages in making the layout of this header more rigid, it was decided that it would not be practicable to produce a layout that would be universally acceptable in the light of how it is currently used.

The 400-byte Binary File Header record contains binary values that can affect the whole SEG-Y file. The values in the Binary File Header are defined as two-byte or four-byte, two's complement integers. Certain values in this header are for processing of the data in the file, particularly the sampling interval, trace length and format code. A few additional fields in the optional portion are defined.

If bytes 3505-3506 of the Binary File Header are non-zero, then an Extended Textual File Header is present in the SEG-Y file. The Extended Textual File Header follows the Binary File Header record and precedes the first Data Trace record. An Extended Textual File Header consists of one or more 3200-byte records and provides additional space for recording required information about the SEG-Y file in a flexible but well-defined way. The kind of information recorded here can include navigation projections, 3-D bin grids, processing history and acquisition parameters. In the event multiple or conflicting data entries are included in a SEG-Y rev 1 file, the last data entry is assumed to be correct.

The SEG-Y trace header contains trace attributes, which are defined as two-byte or four-byte, two's complement integers. The values in bytes 1-180 were defined in the 1975 standard and these entries remain unchanged in a later version, although clarification and extensions may be supplied where appropriate. One revision defines standard locations in bytes 181-240 for certain values that are for use in modern data processing. In particular, standard locations for a shotpoint number and ensemble coordinates are defined. Bytes 203 to 210 allow the measurement units for the Data Trace samples to be defined and transduction constants to be defined. These entries allow the Data Trace values to be converted to engineering units. The values included in the Trace Header are limited and intended to provide information that may change on a trace-by-trace basis and the basic information to process and identify the trace. The trace headers are not intended to be a repository for substantial amounts of ancillary data as such ancillary data can be in an SEG Ancillary Data Standard data set(s).

As an example, a seismic survey framework can provide for automatic metadata information extraction from seismic data, which can be, for example, SEG-Y data or another type of seismic data. As an example, such a framework may be part of or operatively coupled to a framework such as, for example, the PETREL framework or the OMEGA framework.

As explained, SEG-Y is a file format first released in 1975 (SEG-Y rev 0) by the Society of Exploration Geophysicists (SEG) for the purpose of storing geophysical data. The metadata for the SEG-Y file is captured in the EBCDIC or textual header, binary header, and trace headers. The SEG-Y files are large, up to several hundred gigabytes (GB) or even several terabytes (TB) or more. The task of migrating a large number of SEG-Y files from on-premises storage to cloud storage is labor intensive. To automate the migration step, a framework can extract information such as the CRS the data survey is recorded in, the location of in-line and cross-line numbers, and the location of X and Y coordinates from the SEG-Y headers. Unfortunately, the above-mentioned information is not always present in the SEG-Y headers, and, in various instances, it is not reliable when it is available. Incorrect and/or incomplete metadata can hinder usage of SEG-Y files in common geophysical data analysis applications. Thus, it becomes imperative to automatically extract and validate the metadata from SEG-Y files.

As an example, a seismic survey framework can provide a suite of components to achieve automatic extraction of metadata from SEG-Y files or, for example, one or more other types of files. As an example, a framework can provide an end-to-end automatic SEG-Y data ingestion workflow to extract desirable metadata such that a SEG-Y file can be ingested into cloud database and/or be consumed by one or more geophysics data analysis frameworks (e.g., PETREL, OMEGA, etc.). Such a framework can replace or supplement manual processes as performed by domain experts. Manual approaches are intensive and can be in part subjective and they may miss particular aspects of a seismic data file.

As an example, a framework can implement a workflow that automatically extracts metadata from SEG-Y files that can facilitate an SEG-Y file being ingested into a cloud database and/or being consumed by one or more geophysical data analysis frameworks. As an example, a workflow can involve finding the search space in which candidate CRS systems can be evaluated to identify the appropriate CRS system; selecting and applying one or more processes that check orthogonality of bin grids in a current CRS system (e.g., consider a nine (9) angles measure process and a deviation at bin grid vertices process); implementing rule based and machine learning based trace header template identification from SEG-Y textual header; and implementing a rule based process to extract the trace header template directly from the trace headers in the SEG-Y file.

As explained, a framework can include features to implement an end-to-end automatic SEG-Y data ingestion workflow to extract metadata such that a SEG-Y file can be ingested into cloud database and/or be consumed by one or more geophysics data analysis frameworks. Such a framework can include: a component to identify the CRS system associated with the SEG-Y file and recover the bin grid definition and original CRS from SEG-Y files in case they have been reprojected to an incorrect CRS system; and a component to, given a SEG-Y file, automatically extract and validate a trace header template from a textual header where, if the trace header template is found to be invalid upon automatic validation, the component can automatically extract the trace header template from the trace headers.

In seismic surveys, a bin can be a subdivision of a seismic survey. For example, the area of a three-dimensional survey can be divided into bins where the area may be in a geodetic coordinate reference system that can be projected into a CRS (e.g., with coordinates of easting and northing). A bin grid of a seismic survey can be georeferenced to a CRS. Depending on type of survey and acquisition geometry, as an example, a bin may be of the order of 25 m (82 ft) long and 25 m (82 ft) wide; noting that these values may vary from a few meters to 100 meters or more. In seismic surveys, traces are assigned to specific bins, for example, according to a midpoint between a source and a receiver, reflection point, or conversion point. Bins can be assigned according to common midpoint (CMP); noting that more sophisticated seismic processing allows for other types of binning. Data quality can depend in part on the number of traces per bin, or the fold. As to a fold, it relates to stacking where a stack is seismic data that are a processed seismic record that includes traces that have been added together from different seismic records to reduce noise and improve overall data quality. The number of traces that have been added together during stacking is called the fold. Stacking may be performed by averaging a normal moveout (NMO) corrected data set or migrated data set to improve signal-to-noise ratio where, for example, noise components in traces tend to be uncorrelated, normally distributed, stationary, and of relatively equal magnitude. Stacking can occur prior to one or more operations that may be referred to as “post-stack”. For example, consider a post-stack migration that operates on a stacked section that may be assumed to have zero offset. In various examples, raw seismic data can be stacked seismic data such that a framework can access and process a post-stack seismic data file that is considered to be a raw seismic data file. As explained, seismic data can include seismic traces that are grouped into a regularly spaced bin grid covering a seismic survey area. A seismic data file can include information (e.g., metadata) germane to a bin grid, noting that various operations may modify such metadata and/or a bin grid.

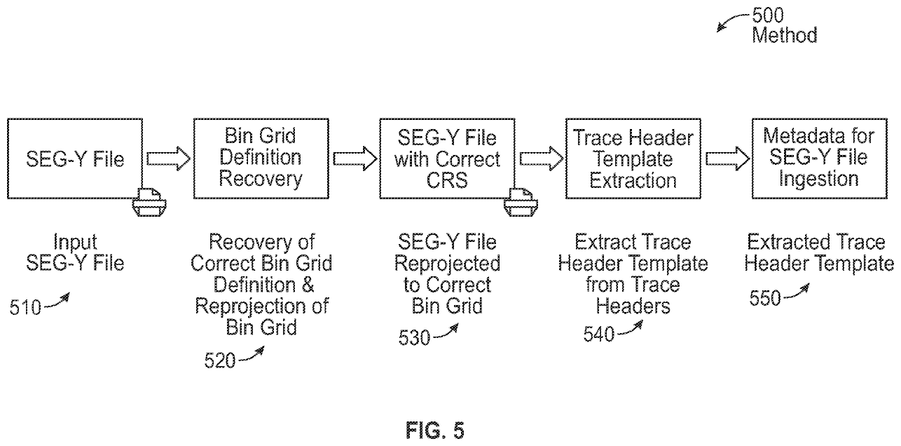

FIG. 5 shows an example of a method 500 that can be implemented using a seismic survey framework. As shown, the method 500 can include a SEG-Y file block 510 for inputting an SEG-Y file, a bin grid definition recovery block 520 for recovery of a correct bin grid definition and reprojections of a bin grid, a SEG-Y output block 530 for output of the SEG-Y file with the appropriate CRS (e.g., SEG-Y file reprojected to the correct bin grid); a trace header template extraction block 540 for extracting a trace header template from trace headers, and a metadata for SEG-Y file output block 550 for outputting metadata suitable for SEG-Y file ingestion, which may be in the form of an extracted trace header template. The method 500 can be an end-to-end workflow that identifies and corrects a CRS system and extracts a trace header template. For example, the method 500 can recover the bin grid definition and extract trace header template from trace headers.

As to bin grid recovery, consider a framework such as the PETREL framework where SEG-Y files with non-orthogonal bin grids are inappropriate as they can fail to load. To address such an issue, a workflow can include performing one or more processes to identify an original CRS from an SEG-Y files that have been reprojected to an unknown CRS. For example, consider the method 300 of FIG. 3 where the modification block 340 has modified seismic data by reprojecting the seismic data to a CRS that differs from an original CRS.

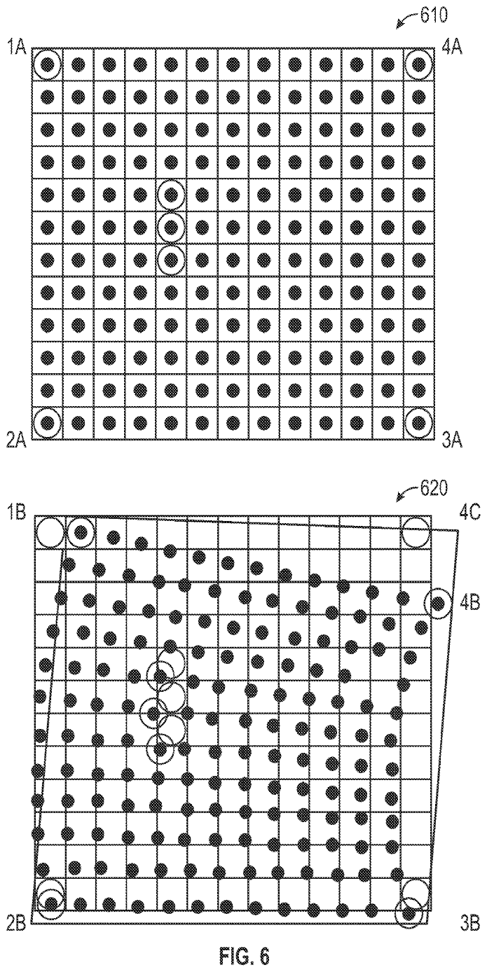

FIG. 6 shows two example bin grids 610 and 620 where the bin grid 610 is orthogonal in the original projected CRS while the bin grid 620 is distorted. In the example of FIG. 6, trace header eastings/northings have been re-projected such that it is no longer possible to construct the orthogonal bin grid 610 from the data. As mentioned, a file with a skewed parallelogram is not an option for various frameworks (e.g., PETREL). As explained, an SEG-Y file with the correct CRS can be generated and ingested once the original CRS system has been identified, which can be performed using one or more processes, referred to as bin grid definition recovery processes. Once identified, the bin grid in the SEG-Y file can be reprojected using the original CRS system.

As explained, a framework can provide for trace header template extraction. As an example, trace header template information can include the byte location for IL and XL numbers, X and Y coordinates, XY scale and Z scale. While this information can be present in the SEG-Y textual header, it may be found to be incorrect. A trace header template extraction component can first extract the trace header template from a textual header using one or more of machine learning and rule-based algorithms and validate the extracted template. For example, one or more natural language processing (NLP) techniques may be utilized in combination with one or more machine learning and/or rule-based techniques. As an example, if the information extracted is found to be invalid, then the framework can extract the trace header template from the trace headers, for example, using one or more rule-based techniques, etc.

As to bin grid definition recovery, seismic data analysis tools lack orthogonality checking criteria when processing bin grids which has led to legacy SEG-Y data with non-orthogonal bin grids. Such SEG-Y files with non-orthogonal bin grids can fail to load in various frameworks (e.g., seismic interpretation tools such as PETREL, etc.). Such legacy SEG-Y files with non-orthogonal bin grids can hinder enhanced understanding of new sub-surfaces in adjacent geography and/or one or more other workflows.

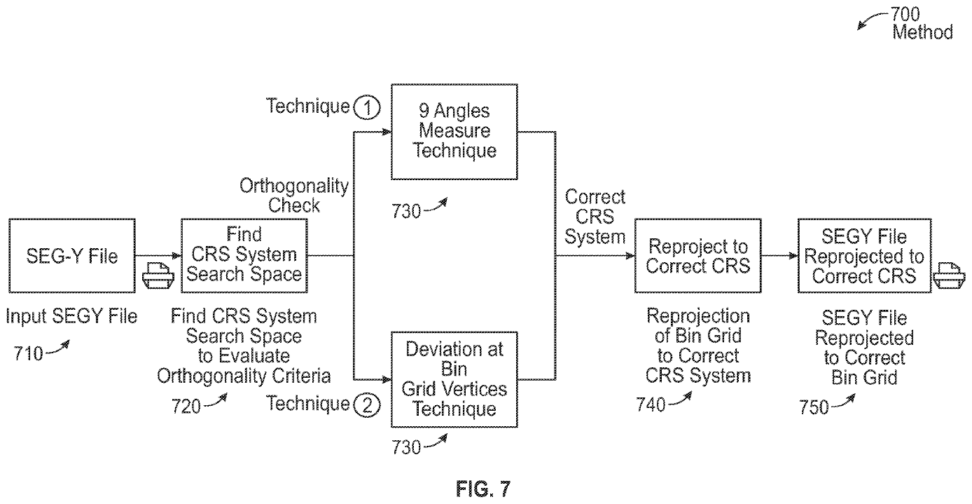

FIG. 7 shows an example of a method 700 that can perform bin grid recovery. As shown, the method 700 can include an input block 710 for input of a SEG-Y file, a find block 720 for finding a CRS system search space for evaluation of orthogonality criteria, one or more orthogonality check blocks 730 that can output a correct CRS, a reprojection block 740 for reprojecting to the correct CRS, and an output block 750 to output the SEG-Y file reprojected to the correct CRS.

As explained, a bin grid can be defined to always be orthogonal in an original projected CRS. As explained, a bin grid definition recovery process can find the CRS system search space to evaluate orthogonality criteria for the bin grid. Next, the process can evaluate the orthogonality criteria using one or more techniques such as, for example, the 9 Angles Measure and the Deviation at the Bin Grid Vertices, which can recommend the original CRS of the SEG-Y file. As explained, the bin grid can be reprojected to the original CRS where an output, reprojected SEG-Y file can be loaded into a cloud storage, a framework (e.g., PETREL, etc.), etc.

In the example of FIG. 7, the block 730 illustrates two example techniques, specifically, the 9 Angles Measure technique and the Deviation at Bin Grid Vertices technique. As explained, once the original CRS is found, the bin grid can be reprojected to the correct CRS system.

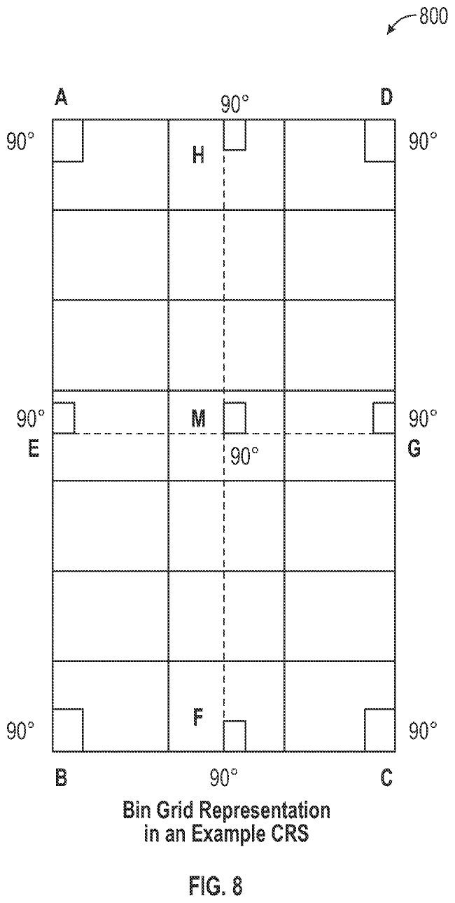

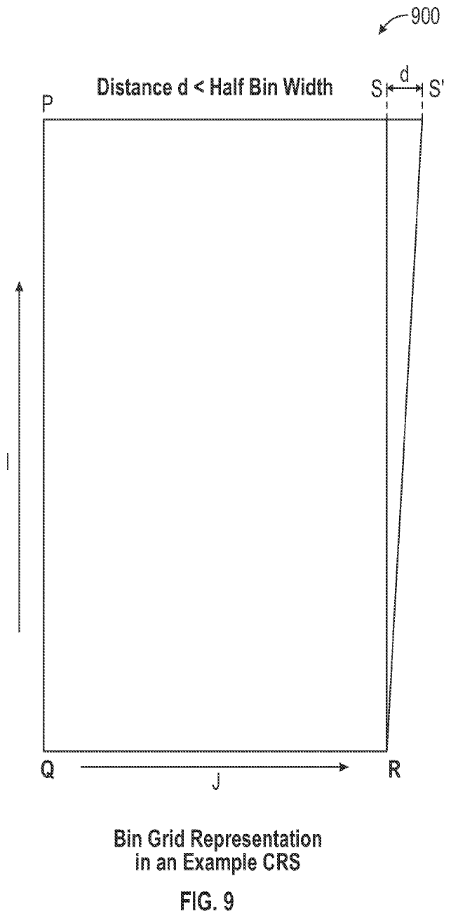

FIG. 8 and FIG. 9 show examples of techniques 800 and 900 for orthogonality check criteria for bin grid reprojection where FIG. 8 illustrates the 9 Angles Measure technique 800 where all angles are to be 90 degrees (e.g., with slight variation within tolerance (e.g., less than 0.02 degrees)) and where FIG. 9 illustrates the Deviation at Bin Grid Vertices technique 900 where a criterion is less than half bin size deviation at bin grid vertices. As an example, angles may be labeled using numbers, letters, a combination of letters and numbers, etc. For example, in FIG. 8, the nine angles are labeled A, B, C, D, E, F, G, H, and M; noting that A1, A2, A3, A4, A5, A6, A7, A8, and A9 or another convention may be utilized. In the example of FIG. 9, the distance d is to be less than half of the bin width (see, e.g., S and S′). Such an approach can accommodate various grid sizes as the distance comparison is referenced with respect to bin width, which provide for a normalization of the distance comparison.

With reference to FIG. 8, the 9 Angles Measure techniques states that the angles formed at A, B, C, D, E, F, G, H, and M are to be close to 90 degrees to qualify a bin grid to be orthogonal; whereas, with reference to FIG. 9, the Deviation at Bin Grid Vertices techniques states that the deviation at the bin grid vertices d is to be less than a half bin width; noting that a suitable criterion or criteria may be defined to achieve an appropriate result akin to the criterion of deviation at the bin grid vertices represented by d to be less than a half bin width. Such a criterion or criteria may provide for some amount of flexibility.

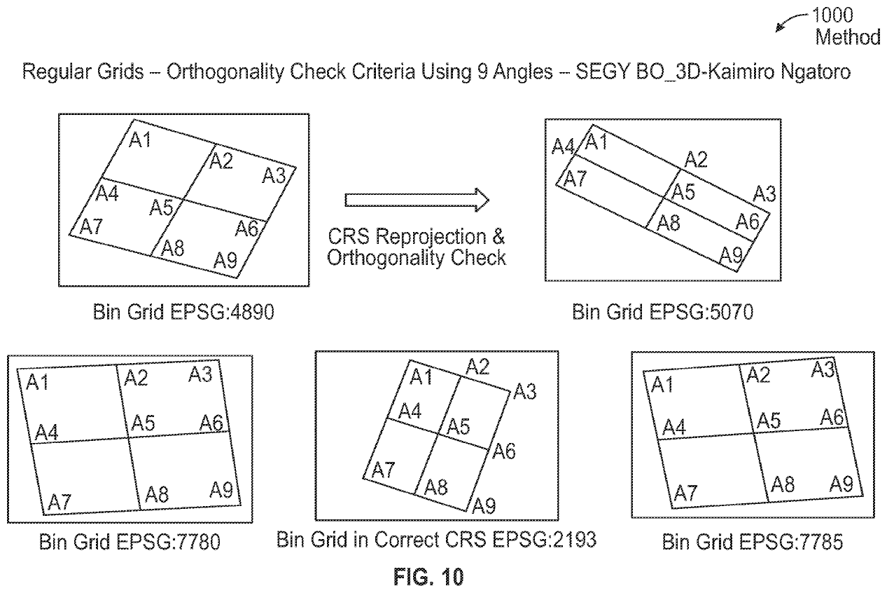

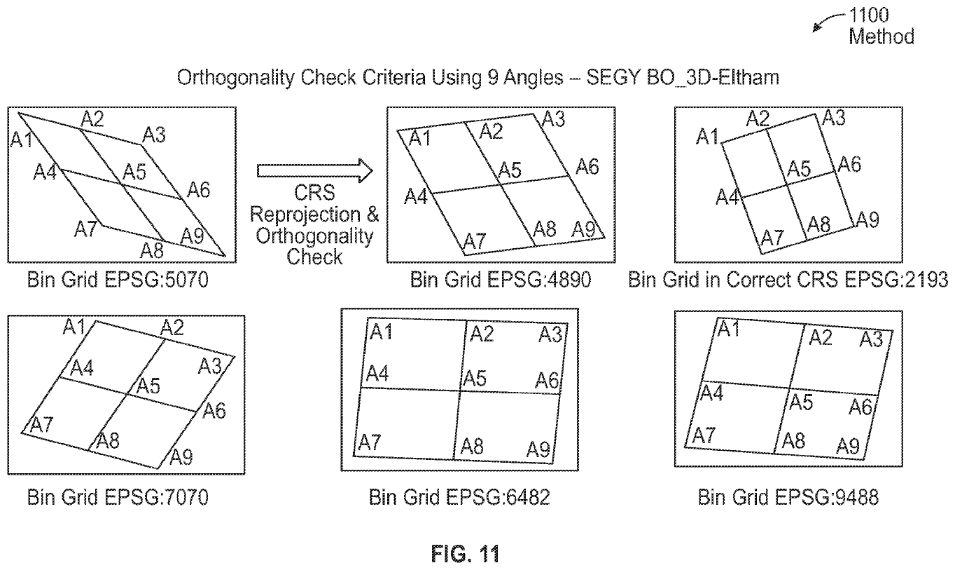

FIG. 10 and FIG. 11 show examples of the 9 Angles Measure technique as applied to seismic data from New Zealand Petroleum and Minerals (NZP&M). The 9 Angles Measure technique can suppose that the rectangle ABCD is a bin grid boundary. This technique checks the orthogonality of the bin grid by evaluating the angles formed at points A, B, C, D, E, F, G, H, and M where, if all of the 9 angles are close to 90 degrees (e.g., with a very slight deviation according to a criterion such as approximately 0.015 degrees) then the bin grid is qualified to be orthogonal (e.g., sufficiently orthogonal for performing one or more workflows using one or more frameworks that may depend on substantial orthogonality).

The Deviation at Bin Grid Vertices technique can suppose that the rectangle PQRS is the boundary of the ideal rectangular bin grid where, however, in the real-world scenario the vertex S is shifted to S′ and bin grid resembles a trapezoid. In such an example, if the distance d between S and S′ is less than half the bin width, then the bin grid is qualified to be orthogonal. In the example of FIG. 11, labels for angles are also shown, for example, to provide for a comparison between the techniques of FIG. 10 and FIG. 11.

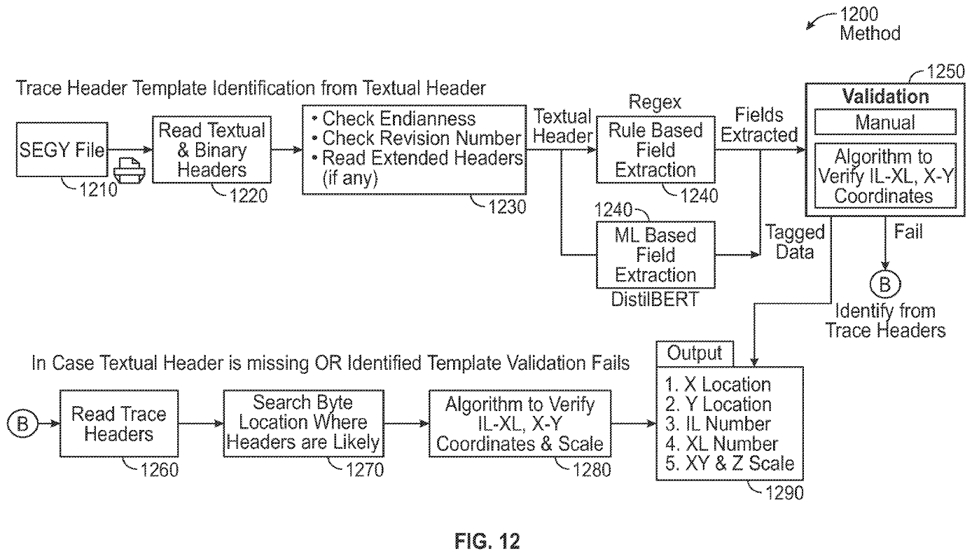

FIG. 12 shows an example of a method 1200 for SEG-Y trace header template identification. In the example of FIG. 12, the method 1200 includes an input block 1210 for inputting a SEG-Y file; a read block 1220 for reading textual and binary headers; a check block 1230 for checking endianness, revision number and extended header(s) (e.g., if present); an extraction block 1240 for extracting fields using one or more techniques; and a validation block 1250 for validation of trace header information. As shown, the validation block 1250 can result in a failure, which can cause the method 1200 to proceed to a read block 1260 for reading trace headers, a search block 1270 for searching byte locations were headers are likely to be present, and a verification block 1280 for verifying IL-XL, X-Y coordinates and scale, which is a process that may be performed in the validation block 1250. In the example of FIG. 12, the method 1200 can include an output block 1290 for output of various information, which can include X location, Y location, IL number, XL number, X and Y scale and Z scale.

In the example of FIG. 12, the block 1240 can implement one or more of rule-based field extraction and machine learning-based field extraction. For example, consider use of regular expression (also called regex or regexp) as a way to describe one or more patterns. As an example, regex can be used to locate or validate specific strings or patterns of text in a sentence, document, or other character input. Regular expressions can use basic and special characters where basic characters can include standard letters, numbers, and general keyboard characters, while other characters are considered special. As to a machine learning-based approach, consider DistilBERT, which based on the BERT model. In particular, the size of a BERT model can be reduced via knowledge distillation during pre-training phase while retaining over 90 percent of its language understanding abilities while performing substantially faster. Bidirectional Encoder Representations from Transformers (BERT) is a family of masked-language models composed of transformer encoder layers. As an example, one or more other types of natural language processing (NLP) models may be utilized. For example, consider one or more technologies of the GPT-3, GPT-4, etc. (e.g., Generative Pre-trained Transformer 3, 4, etc.), which is an autoregressive language model.

An article by Sanh et al., entitled “DistilBERT, a distilled version of BERT: smaller, faster, cheaper and lighter”, 5th Workshop on Energy Efficient Machine Learning and Cognitive Computing, NeurIPS 2019, arXiv: 1910.01108, is incorporated by reference herein.

As an example, a foundational GPT model may be further adapted to produce more targeted systems directed to specific tasks and/or subject-matter domains. Techniques for such adaptation may include additional fine-tuning (e.g., beyond tuning of a foundation model, etc.), certain forms of prompt engineering, etc. As an example, a large language model (LLM) may be a chatbot type of LLM. For example, consider the OpenAI ChatGPT LLM, which is an online chat interface powered by an instruction-tuned language model trained in a similar fashion to InstructGPT. Other chatbots may include features of GPT-4 (OpenAI), Bard (e.g., LaMDA family of conversation-trained language models, PaLM, etc.) (Google, Mountain View, California), etc.

As an example, a LLM Meta Al (LLaMA) LLM may be utilized, which includes a transformer architecture; noting some architectural differences compared to GPT-3. For example, LLaMA utilizes the SwiGLU activation function rather than ReLU, uses rotary positional embeddings rather than absolute positional embedding, and uses root-mean-squared layer-normalization rather than standard layer-normalization. Further, there may be an increase in context length from 2K (Llama 1) tokens to 4K (Llama 2) tokens between.

As an example, a trace header template can be informative as to where in the trace header relevant information is located. Specifically, a trace header template can mention the byte location for X coordinates, Y coordinates, inline (IL) number, crossline (XL) number, XY scale and Z scale.

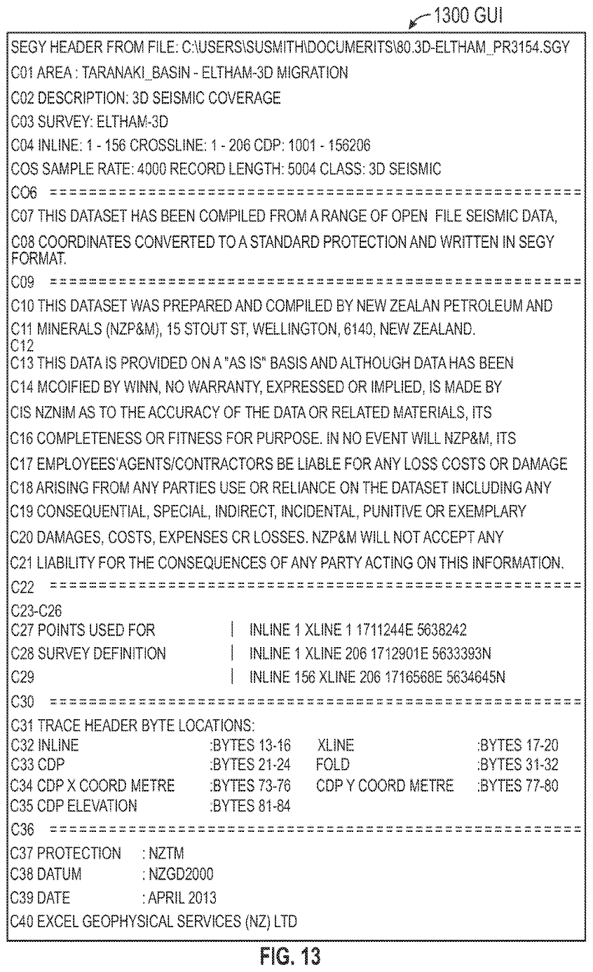

FIG. 13 shows an example of a graphical user interface (GUI) 1300 that renders header information from seismic data from New Zealand Petroleum and Minerals (NZP&M) with information in EBCDIC, that includes: in-line, crossline numbers; X & Y coordinates; Coordinate reference system (CRS); Scaling factors; Survey name and description; Processing company; Details of processing (time / depth); and Details of content (attribute).

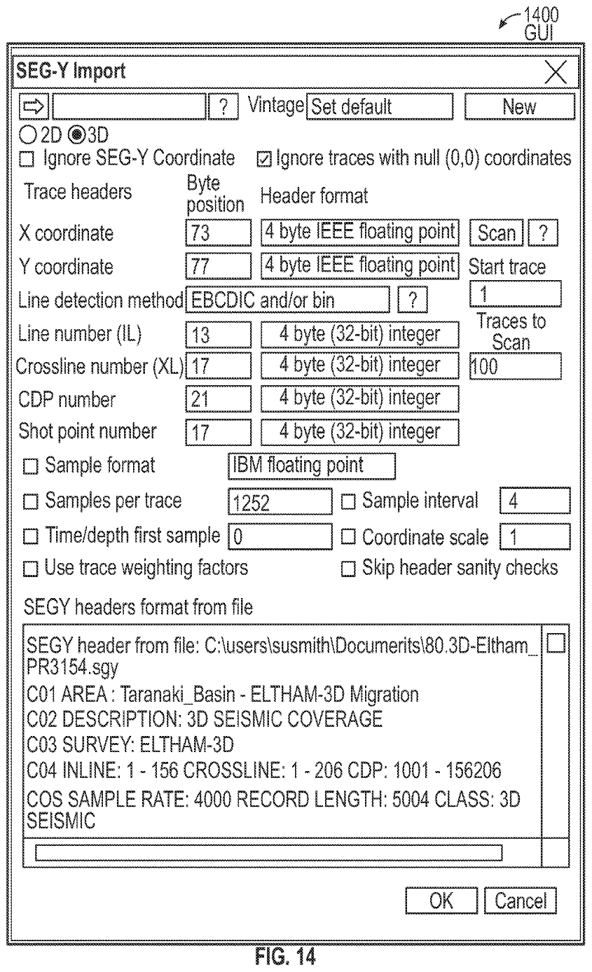

FIG. 14 shows an example of a graphical user interface (GUI) 1400 where the trace header template indicates where in the trace header to locate relevant information such as, for example: X location at Bytes 73-76; Y location at Bytes 77-80; IL number at Bytes 13-16; and XL number at Bytes 17-20. Additional information can include XY scale and Z scale. As an example, the GUI 1400 can be part of a workflow implemented using a framework that ingests seismic data such as, for example, the PETREL framework. As an example, a seismic survey framework that can provide for handling of seismic data may be implemented as part of the PETREL framework (e.g., via an application programming interface (API) call, as a plug-in, etc.).

As explained, template information can be most probably present in the textual header for most of the SEG-Y files. However, SEG-Y files are often modified post where they are generated but the textual header is left unchanged, which leads to a mismatch between the actual trace header template and the one captured in the textual header. Thus, the workflow for trace header template identification can include a sequence of actions, one each for extracting trace header template from the textual header and trace headers.

As explained, a framework can provide for trace header template identification by trace header template extraction from the textual header and validated where, if the validation fails, the trace header template can be extracted from the trace headers. As an example, a method can include reading the textual/EBCDIC header & binary headers from an SEG-Y file, where the textual header is present in the first 3200 bytes while the binary header resides in the next 400 bytes locations. In such an example, binary header processing can involve reading the binary header and checking the appropriate byte locations for endianness, revision number and extended headers. For example, endianness information can be available in byte locations 3225 and 3226 while revision number (0/1/2) information is present in byte locations 3501 and 3502. The presence/absence of extended headers can be captured in the byte locations 3505-3506 where, if present, the size of each extended header is 3200 bytes.

As to trace header template extraction, as explained, an extraction process can extract the trace header template information using rule-based (regex) and/or machine learning (ML) based field extraction. In such examples, the rule-based approach can extract IL & XL number byte locations, X & Y coordinate byte locations, XY & Z scale byte locations from the textual header using regex. As to an ML-based approach, as mentioned, a model such as the DistilBERT model may be implemented, which can be trained in a supervised setting to recognize and extract trace header template information as IL & XL number byte locations, X & Y coordinate byte locations, XY & Z scale byte locations from the textual header. The DistilBERT model can be trained using a training corpus that includes textual headers from SEG-Y files.

As to validation, it can be performed manually and/or automatically using one or more techniques to verify IL-XL & X-Y coordinates. For example, if the validation succeeds, a trace header template output can be provided (e.g., in a JSON format); whereas, if the validation fails, additional actions can be taken. As to manual verification, this may be performed by rendering GUIs for observing patterns of slopes and discontinuities of trace header byte locations. As an example, one or more ML approaches may be utilized for pattern recognition, which may supplement and/or supplant human intervention. For example, a trained ML model may provide for recognition of one or more patterns and for feedback, which may guide a framework and/or guide a human.

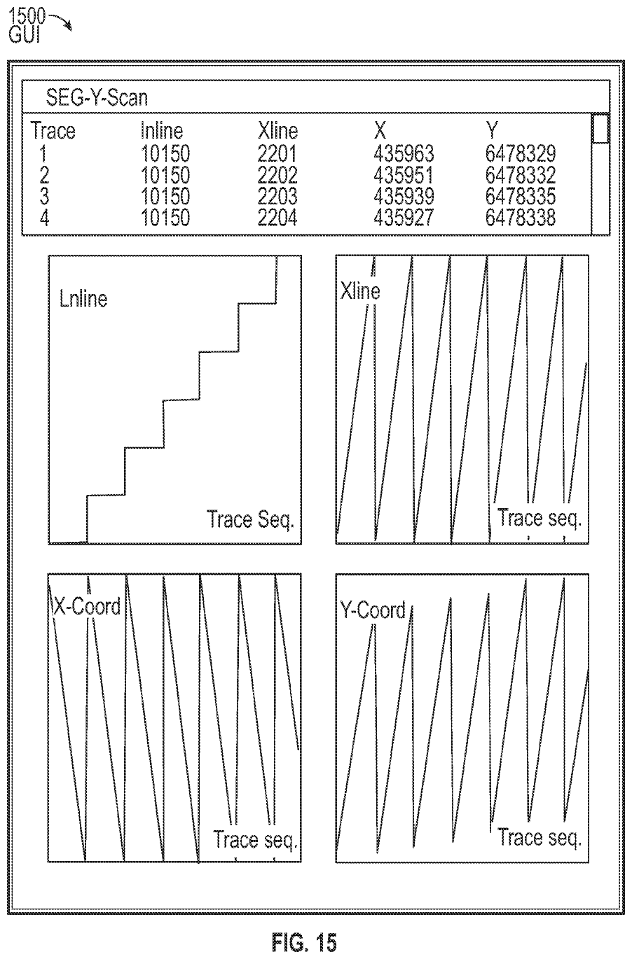

FIG. 15 shows an example of a GUI 1500 that renders examples of a correct trace header template pattern. As shown, verification of trace header template byte location can be via observing the patterns of slopes and discontinuities of trace header byte locations (e.g., via one or more features accessible via PETREL, etc.). In the example GUI 1500, the vertical lines may be present or absent, as they merely indicate transitions. For example, a pattern may or may not include the vertical lines. As to scanning seismic data until a pattern emerges, as explained, a number of traces may be considered such as, for example, 2000 traces, which may be sufficient for purposes of uncovering a pattern. As to a total number of traces in a seismic data file, depending on seismic survey technique, it can be in excess of ten thousand, one hundred thousand, one million, etc. As an example, a number of traces can be sufficient to move beyond a first inline or a first crossline.

As an example, a framework may be employed for seismic data where multiple sets of seismic data have been combined into a single seismic data file. In such an example, one or more additional checks may be performed, for example, as to gaps, null fills (e.g., padding), etc. As an example, output from a framework may provide for more accurately combining sets of seismic data.

As to trace header template Identification from trace headers, as explained, this can include reading trace headers for the probable byte locations as 5, 9, 13, 17, 21, 25, 73, 77, 81, 85, 181, 185, 189, 193, 221 and 225. In such an example, each byte location can be evaluated for presence of IL number, XL number, X coordinate and Y coordinate. As an example, an evaluation can be performed using a multi-state finite state machine. As explained, identified trace header template information can be provided as output, for example, in the form of a JSON document.

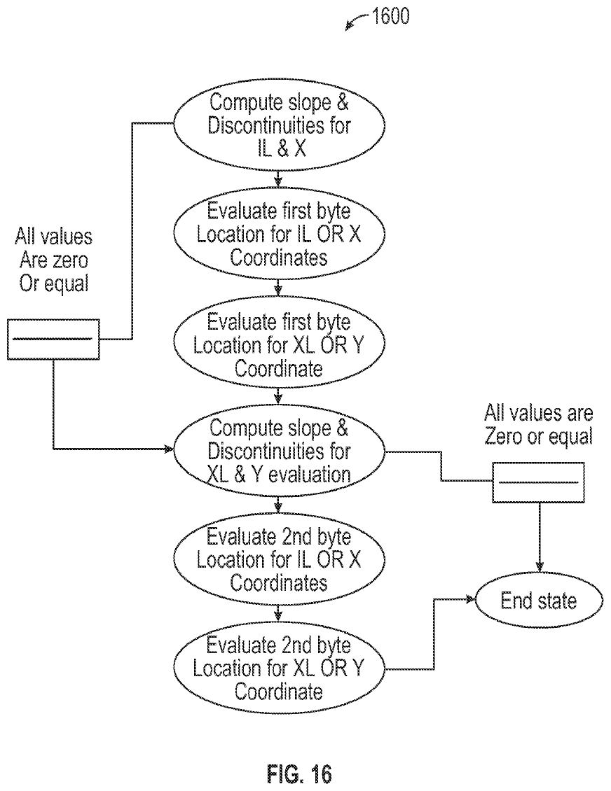

FIG. 16 shows an example of a method 1600 that can implement a Finite State Machine (FSM) for trace header template identification. As shown, an FSM can include 7 states where the FSM evaluates the byte location in pairs as byte locations 5 & 9, 13 & 17, and so on. As an example, the number of trace headers chosen for an evaluation can be greater than a few hundred and may be increased as appropriate. As an example, 2000 traces may be selected for evaluation (e.g., first 2000 traces) which proved to be a reliable and accurate approach without having to iterate to an increased number of traces. For example, where 500 traces are selected, if results are not adequate, then a second round with 1000 traces may be performed. However, selecting 2000 traces to start may prove more efficient and accurate. If 2000 traces are ineffective, this number may be increased by doubling its value in the next iteration if the FSM cannot extract the trace header template in the current iteration.

In the example of FIG. 16, each state can evaluate the byte location to extract a parameter in trace header template. For example, consider an FSM that can operate as indicated below:
a. Compute Slope & Discontinuities for IL & X: This state sets the context for byte location evaluation by computing the slope and discontinuities occurring in the plot; where the byte location value is plotted on y-axis and the number of trace header is plotted on x-axis. If all values for the byte location are equal or zero, then the state transitions to the fourth state, else its transitions to the next state.
b. Evaluate first byte location for IL OR X coordinates: This state evaluates the slope of the lines for the first byte location in the pair. If the slope is zero for all the lines with discontinuities, then its IL byte location. Also, if the slope is more than zero and equal for the lines then it's an X coordinate byte location. The state transitions to the next state after the evaluation.
c. Evaluate first byte location for XL OR Y coordinate: This state evaluates the slope of the lines for the first byte location in the pair. If the slope is equal for all the lines with same discontinuities as observed in IL byte location, then it's a XL byte location. If the slope is more than zero and equal for all the lines with different discontinuities as in IL byte location, then it's a Y coordinate byte location. The state transitions to the next state after the evaluation.
d. Compute Slope & Discontinuities for XL & Y evaluation: This state sets the context for byte location evaluation by computing the slope and discontinuities occurring in the plot; where the byte location value is plotted on y-axis and the number of trace header is plotted on x-axis. If all values for the byte location are equal or zero, then the state transitions to the end state, else its transitions to the next state.
e. Evaluate Second byte location for IL OR X coordinates: This state evaluates the slope of the lines for the second byte location in the pair. If the slope is zero for all the lines with discontinuities, then its IL byte location. Also, if the slope is more than zero and equal for the lines then it's an X coordinate byte location. The state transitions to the next state after the evaluation.
f. Evaluate Second byte location for XL OR Y coordinate: This state evaluates the slope of the lines for the second byte location in the pair. If the slope is equal for all the lines with same discontinuities as observed in IL byte location, then it's a XL byte location. If the slope is more than zero and equal for all the lines with different discontinuities as in IL byte location, then it's a Y coordinate byte location. The state transitions to the next state after the evaluation.
g. End State: This is the last state of the FSM and the evaluation is completed for the byte location pair.
At the end of FSM execution for the probable byte locations, the trace header template identification can be concluded.

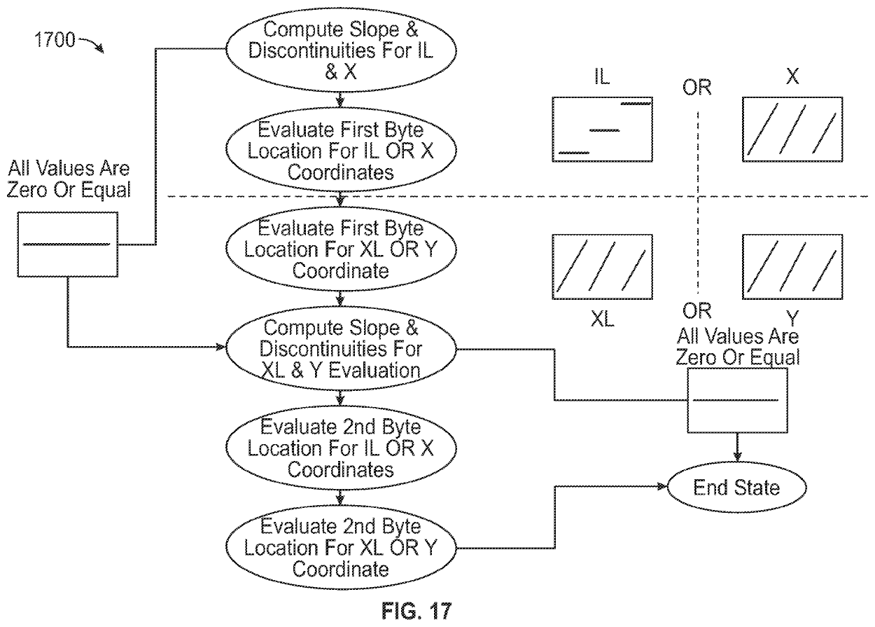

FIG. 17 also shows an example of a method 1700, which may be implemented using an FSM. In FIG. 17, the method 1700 is shown along with graphics as to some of the various conditions that can be associated with some of the states.

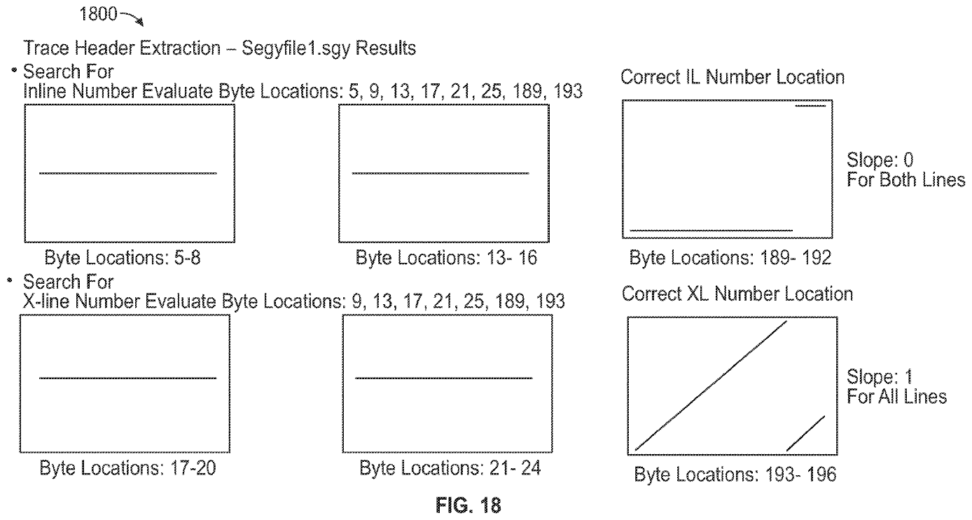

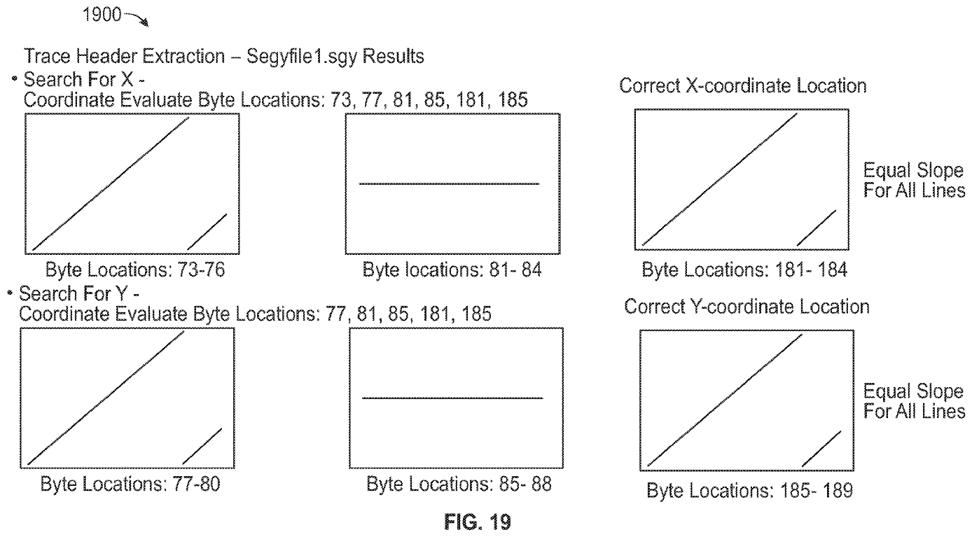

FIG. 18 and FIG. 19 show examples of results of operations with example graphics 1800 and 1900 for trace header extraction for a particular SEG-Y file. In particular, the graphics 1800 and 1900 demonstrate automated trace header template extraction results for evaluating probable byte locations for IL number, XL number, X coordinate and Y coordinate presence. As explained, such an approach can operate automatically or semi-automatically. As explained, one or more types of machine learning techniques, pattern recognition techniques, etc., may be implemented as part of a trace header extraction process.

As to types of machine learning models, consider one or more of a support vector machine (SVM) model, a k-nearest neighbors (KNN) model, an ensemble classifier model, a neural network (NN) model, etc. As an example, a machine learning model can be a deep learning model (e.g., deep Boltzmann machine, deep belief network, convolutional neural network, stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine model may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange various other frameworks.

As an example, the TENSORFLOW framework (Google LLC, Mountain View, CA) may be implemented, which is an open source software library for dataflow programming that includes a symbolic math library, which can be implemented for machine learning applications that can include neural networks. As an example, the CAFFE framework may be implemented, which is a DL framework developed by Berkeley Al Research (BAIR) (University of California, Berkeley, California). As another example, consider the SCIKIT platform (e.g., scikit-learn), which utilizes the PYTHON programming language. As an example, a framework such as the APOLLO Al framework may be utilized (APOLLO. AI GmbH, Germany). As an example, a framework such as the PYTORCH framework may be utilized (Facebook Al Research Lab (FAIR), Facebook, Inc., Menlo Park, California).

As an example, a training method can include various actions that can operate on a dataset to train a ML model. As an example, a dataset can be split into training data and test data where test data can provide for evaluation. A method can include cross-validation of parameters and best parameters, which can be provided for model training.

The TENSORFLOW framework can run on multiple CPUs and GPUS (with optional CUDA (NVIDIA Corp., Santa Clara, California) and SYCL (The Khronos Group Inc., Beaverton, Oregon) extensions for general-purpose computing on graphics processing units (GPUS)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system based platforms.

TENSORFLOW computations can be expressed as stateful dataflow graphs; noting that the name TENSORFLOW derives from the operations that such neural networks perform on multidimensional data arrays. Such arrays can be referred to as “tensors”.

As an example, a device may utilize TENSORFLOW LITE (TFL) or another type of lightweight framework. TFL is a set of tools that enables on-device machine learning where models may run on mobile, embedded, and loT devices. TFL is optimized for on-device machine learning, by addressing latency (no round-trip to a server), privacy (no personal data leaves the device), connectivity (Internet connectivity is demanded), size (reduced model and binary size) and power consumption (e.g., efficient inference and a lack of network connections). TFL offers multiple platform support, covering ANDROID and iOS devices, embedded LINUX, and microcontrollers; diverse language support, which includes JAVA, SWIFT, Objective-C, C++, and PYTHON; high performance, with hardware acceleration and model optimization. Machine learning tasks may include, for example, image classification, object detection, pose estimation, question answering, text classification, etc., on one or more of multiple platforms.

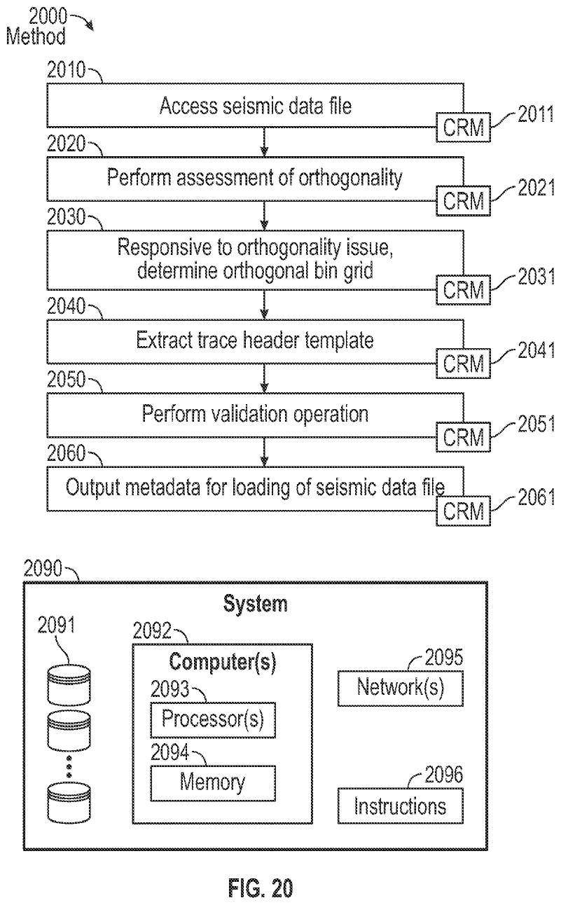

FIG. 20 shows an example of a method 2000 and an example of a system 2090. As shown, the method 2000 can include an access block 2010 for accessing a seismic data file for a seismic survey defined in part by a bin grid, where seismic data in the seismic data file are organized according to a data structure that includes headers and seismic trace data, where the headers include one or more introductory headers and multiple trace headers; a performance block 2020 for performing an assessment of orthogonality of the bin grid of the seismic data file; a definition block 2030 for, responsive to detection of an orthogonality issue by the assessment, determining an orthogonal bin grid; an extraction block 2040 for extracting a trace header template using at least one of the one or more introductory headers, where the trace header template specifies at least trace locations; a performance block 2050 for performing a validation operation for validation of the trace header template; and an output block 2060 for, responsive to validation of the trace header template, outputting metadata that comports with the orthogonal bin grid and the validated trace header template for loading of the seismic data file to a data storage system. Such a method may further include loading the seismic data file to the data storage system where the seismic data file can be utilized for one or more purposes.

The method 2000 is shown in FIG. 20 in association with various computer-readable media (CRM) blocks 2011, 2021, 2031, 2041, 2051, and 2061. Such blocks generally include instructions suitable for execution by one or more processors (or processor cores) to instruct a computing device or system to perform one or more actions. While various blocks are shown, a single medium may be configured with instructions to allow for, at least in part, performance of various actions of the method 2000. As an example, a computer-readable medium (CRM) may be a computer-readable storage medium that is non-transitory and that is not a carrier wave. As an example, one or more of the blocks 2011, 2021, 2031, 2041, 2051, and 2061 may be in the form processor-executable instructions.

In the example of FIG. 20, the system 2090 includes one or more information storage devices 2091, one or more computers 2092, one or more networks 2095 and instructions 2096. As to the one or more computers 2092, each computer may include one or more processors (e.g., or processing cores) 2093 and memory 2094 for storing the instructions 2096, for example, executable by at least one of the one or more processors 2093 (see, e.g., the blocks 2011, 2021, 2031, 2041, 2051, and 2061). As an example, a computer may include one or more network interfaces (e.g., wired or wireless), one or more graphics cards, a display interface (e.g., wired or wireless), etc.

As an example, a method can include accessing a seismic data file for a seismic survey defined in part by a bin grid, where seismic data in the seismic data file are organized according to a data structure that includes headers and seismic trace data, where the headers include one or more introductory headers and multiple trace headers; performing an assessment of orthogonality of the bin grid of the seismic data file; responsive to detection of an orthogonality issue by the assessment, determining an orthogonal bin grid; extracting a trace header template using at least one of the one or more introductory headers, where the trace header template specifies at least trace locations; performing a validation operation for validation of the trace header template; and responsive to validation of the trace header template, outputting metadata that comports with the orthogonal bin grid and the validated trace header template for loading of the seismic data file to a data storage system. In such an example, the data storage system can be a cloud-platform data storage system (e.g., GOOGLE, AMAZON, MICROSOFT, etc.).

As an example, a data storage system can be accessible by a computational framework for processing and interpretation of seismic trace data based at least in part on at least a portion of metadata, as may be generated by a seismic survey framework.

As an example, an assessment of orthogonality of a bin grid can include applying one or more orthogonality detection techniques, where orthogonality is defined using one or more criteria that can include at least one angle threshold criterion. In such an example, the one or more orthogonality detection techniques can include one or more of a 9 Angles Measure technique and a Deviation at Bin Grid Vertices technique. As an example, a method can include performing an assessment of orthogonality of a by applying a 9 Angles Measure technique and a Deviation at Bin Grid Vertices technique.

As an example, an assessment of orthogonality can include determining whether a coordinate reference system of a bin grid of a seismic data file is not an original coordinate reference system for the seismic survey.

As an example, a method can include determining an orthogonal bin grid by reprojecting a bin grid to a desired coordinate reference system. In such an example, the desired coordinate reference system can be an original coordinate reference system for a seismic survey.

As an example, a method can include, responsive to invalidation of a trace header template, extracting a new trace header template using a number of trace headers. In such an example, the number of the trace headers may be, for example, greater than 200 and less than 20,000 or, for example, greater than 1 and less than 100,000; noting that 100,000 or more trace headers may be utilized.

As an example, a method can include extracting a new trace header template by implementing a finite state machine. In such an example, the finite state machine can evaluate byte location pairs.

As an example, a method can include extracting a trace header template using at least one of one or more introductory headers using one or more techniques. For example, consider one or more of a rule-based field extraction technique and a natural language processing, machine learning-based technique. As an example, a natural language processing machine learning-based technique can be or include a bidirectional encoder representations from transformers-based technique (e.g., BERT or DistilBERT).

As an example, a validation operation can include implementation of one or more pattern recognition techniques for recognition of one or more patterns in one or more of inline identifier versus trace sequence, crossline identifier versus trace sequence, X coordinate versus trace sequence, and Y coordinate versus trace sequence.

As an example, seismic trace data of a seismic data file can include stacked seismic trace data.

As an example, a system can include a processor; a memory operatively coupled to the processor; processor-executable instructions stored in the memory and executable to instruct the system to: access a seismic data file for a seismic survey defined in part by a bin grid, where seismic data in the seismic data file are organized according to a data structure that includes headers and seismic trace data, where the headers include one or more introductory headers and multiple trace headers; perform an assessment of orthogonality of the bin grid of the seismic data file; responsive to detection of an orthogonality issue by the assessment, determine an orthogonal bin grid; extract a trace header template using at least one of the one or more introductory headers, where the trace header template specifies at least trace locations; perform a validation operation for validation of the trace header template; and, responsive to validation of the trace header template, output metadata that comports with the orthogonal bin grid and the validated trace header template for loading of the seismic data file to a data storage system.

As an example, one or more computer-readable storage media can include processor-executable instructions executable by a system to instruct the system to: access a seismic data file for a seismic survey defined in part by a bin grid, where seismic data in the seismic data file are organized according to a data structure that includes headers and seismic trace data, where the headers include one or more introductory headers and multiple trace headers; perform an assessment of orthogonality of the bin grid of the seismic data file; responsive to detection of an orthogonality issue by the assessment, determine an orthogonal bin grid; extract a trace header template using at least one of the one or more introductory headers, where the trace header template specifies at least trace locations; perform a validation operation for validation of the trace header template; and, responsive to validation of the trace header template, output metadata that comports with the orthogonal bin grid and the validated trace header template for loading of the seismic data file to a data storage system.

As an example, a computer program product can include one or more computer-readable storage media that can include processor-executable instructions to instruct a computing system to perform one or more methods and/or one or more portions of a method.

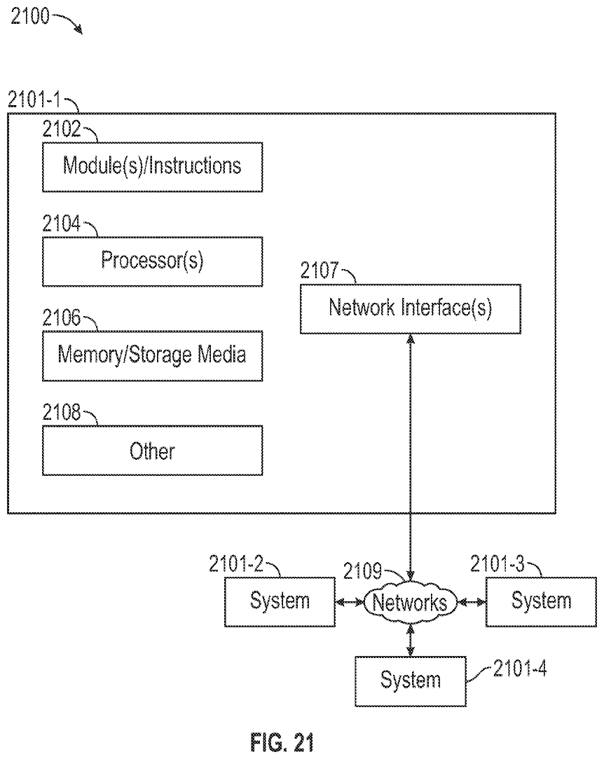

In some embodiments, a method or methods may be executed by a computing system. FIG. 21 shows an example of a system 2100 that can include one or more computing systems 2101-1, 2101-2, 2101-3 and 2101-4, which may be operatively coupled via one or more networks 2109, which may include wired and/or wireless networks.

As an example, a system can include an individual computer system or an arrangement of distributed computer systems. In the example of FIG. 21, the computer system 2101-1 can include one or more modules 2102, which may be or include processor-executable instructions, for example, executable to perform various tasks (e.g., receiving information, requesting information, processing information, simulation, outputting information, etc.).

As an example, a module may be executed independently, or in coordination with, one or more processors 2104, which is (or are) operatively coupled to one or more storage media 2106 (e.g., via wire, wirelessly, etc.). As an example, one or more of the one or more processors 2104 can be operatively coupled to at least one of one or more network interfaces 2107; noting that one or more other components 2108 may also be included. In such an example, the computer system 2101-1 can transmit and/or receive information, for example, via the one or more networks 2109 (e.g., consider one or more of the Internet, a private network, a cellular network, a satellite network, etc.).

As an example, the computer system 2101-1 may receive from and/or transmit information to one or more other devices, which may be or include, for example, one or more of the computer systems 2101-2, etc. A device may be located in a physical location that differs from that of the computer system 2101-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 2106 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution. As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general purpose processors or application specific chips (e.g., or chipsets), such as ASICs, FPGAs, PLDs, or other appropriate devices.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
accessing a seismic data file for a seismic survey defined in part by a bin grid, wherein seismic data in the seismic data file are organized according to a data structure that comprises headers and seismic trace data, wherein the headers comprise one or more introductory headers and multiple trace headers;
performing an assessment of orthogonality of the bin grid of the seismic data file;
responsive to detection of an orthogonality issue by the assessment, determining an orthogonal bin grid;
extracting a trace header template using at least one of the one or more introductory headers, wherein the trace header template specifies at least trace locations;
performing a validation operation for validation of the trace header template; and
responsive to validation of the trace header template, outputting metadata that comports with the orthogonal bin grid and the validated trace header template for loading of the seismic data file to a data storage system.

2. The method of claim 1, wherein the data storage system comprises a cloud-platform data storage system.

3. The method of claim 2, wherein the data storage system is accessible by a computational framework for processing and interpretation of the seismic trace data based at least in part on at least a portion of the metadata.

4. The method of claim 1, wherein the assessment of orthogonality of the bin grid comprises applying one or more orthogonality detection techniques, wherein orthogonality is defined using one or more criteria that comprise at least one angle threshold criterion.

5. The method of claim 4, wherein the one or more orthogonality detection techniques comprise one or more of a 9 Angles Measure technique and a Deviation at Bin Grid Vertices technique.

6. The method of claim 1, wherein the assessment of orthogonality of the bin grid comprises applying a 9 Angles Measure technique and a Deviation at Bin Grid Vertices technique.

7. The method of claim 1, wherein the assessment of orthogonality comprises determining whether a coordinate reference system of the bin grid of the seismic data file is not an original coordinate reference system for the seismic survey.

8. The method of claim 1, wherein the determining an orthogonal bin grid comprises reprojecting the bin grid to a desired coordinate reference system.

9. The method of claim 8, wherein the desired coordinate reference system is an original coordinate reference system for the seismic survey.

10. The method of claim 1, comprising, responsive to invalidation of the trace header template, extracting a new trace header template using a number of the trace headers.

11. The method of claim 10, wherein the number of the trace headers is greater than 1 and less than 100,000.

12. The method of claim 10, wherein the extracting a new trace header template comprises implementing a finite state machine.

13. The method of claim 12, wherein the finite state machine evaluates byte location pairs.

14. The method of claim 1, wherein the extracting the trace header template using at least one of the one or more introductory headers comprises using one or more techniques.

15. The method of claim 14, wherein the one or more techniques comprise one or more of a rule-based field extraction technique and a natural language processing, machine learning-based technique.

16. The method of claim 15, wherein the natural language processing machine learning-based technique comprises a bidirectional encoder representations from transformers-based technique.

17. The method of claim 1, wherein the validation operation comprises implementation of one or more pattern recognition techniques for recognition of one or more patterns in one or more of inline identifier versus trace sequence, crossline identifier versus trace sequence, X coordinate versus trace sequence, and Y coordinate versus trace sequence.

18. The method of claim 1, wherein the seismic trace data comprise stacked seismic trace data.

19. A system comprising:
a processor;
a memory operatively coupled to the processor; and
processor-executable instructions stored in the memory and executable to instruct the system to:
access a seismic data file for a seismic survey defined in part by a bin grid, wherein seismic data in the seismic data file are organized according to a data structure that comprises headers and seismic trace data, wherein the headers comprise one or more introductory headers and multiple trace headers;
perform an assessment of orthogonality of the bin grid of the seismic data file;
responsive to detection of an orthogonality issue by the assessment, determine an orthogonal bin grid;
extract a trace header template using at least one of the one or more introductory headers, wherein the trace header template specifies at least trace locations;
perform a validation operation for validation of the trace header template; and
responsive to validation of the trace header template, output metadata that comports with the orthogonal bin grid and the validated trace header template for loading of the seismic data file to a data storage system.

20. One or more computer-readable storage media comprising processor-executable instructions executable by a system to instruct the system to:
access a seismic data file for a seismic survey defined in part by a bin grid, wherein seismic data in the seismic data file are organized according to a data structure that comprises headers and seismic trace data, wherein the headers comprise one or more introductory headers and multiple trace headers;
perform an assessment of orthogonality of the bin grid of the seismic data file;
responsive to detection of an orthogonality issue by the assessment, determine an orthogonal bin grid;
extract a trace header template using at least one of the one or more introductory headers, wherein the trace header template specifies at least trace locations;
perform a validation operation for validation of the trace header template; and
responsive to validation of the trace header template, output metadata that comports with the orthogonal bin grid and the validated trace header template for loading of the seismic data file to a data storage system.
